(19) United States
(12) Patent Application Publication
(10) Pub. No.: US 2025/0025364 A1
(43) Pub. Date: Jan. 23, 2025

(54) PERTURBED WALKING TRAINING SYSTEM FOR IMPROVING BALANCE CONTROL

(71) Applicant: B. G. NEGEV TECHNOLOGIES AND APPLICATIONS LTD., Beer-Sheva (IL)

(72) Inventors: Itshak MELZER, Lehavim (IL); Amir SHAPIRO, Meitar (IL)

(21) Appl. No.: 18/888,404

(22) Filed: Sep. 18, 2024

Related U.S. Application Data
(63) Continuation of application No. PCT/IL2023/050382, filed on Apr. 10, 2023.
(60) Provisional application No. 63/330,314, filed on Apr. 13, 2022.
(60) Provisional application No. 63/345,427, filed on May 25, 2022.

(51) Int. Cl. A61H 1/02

(52) U.S. Cl. CPC A61H 1/0262; A61H 1/0214

(57) ABSTRACT

Provided herein is a mechatronic supported in-place walking system that provides various types of expected and unexpected perturbations to challenge the proactive and reactive balance control in a subject to thereby improve balance control of the subject. The system includes a motion capture unit and a central control unit capable of analyzing the subject's response to the perturbations, provide real time feedback, adjust and/or determine training sessions.

### CROSS REFERENCE TO RELATED APPLICATIONS

This application is a Bypass Continuation of PCT Patent Application No. PCT/IL2023/050382 having International filing date of Apr. 10, 2023, which claims the benefit of priority of U.S. Provisional Patent Application Nos. 63/330,314, filed Apr. 13, 2022 and 63/345,427, filed May 25, 2022, the contents of which are all incorporated herein by reference in their entirety.

### FIELD OF THE INVENTION

The present disclosure generally relates to trainers for improving balance control, and more specifically to a trainer system that provides unexpected perturbations during in-place walking, and methods of using the same for improving balance control of a user.

### BACKGROUND OF THE INVENTION

The increasing proportion of the elderly population and their associated morbidity is placing pressure on overall health care resources. The leading cause of fatal and nonfatal injuries in this population are falls. More than 30% of community-dwelling elderly people, and about 50% of people who are 80 years old and older, fall at least once a year. About 20-30% suffer acute injuries after falling, such as hip fractures and traumatic brain injuries, that reduce mobility, independence, and may even result in death. The medical costs of elderly falls in the US in 2015 was above $50 billion. Balance control plays a critical role in preventing falls and preserving functional independence, and specifically helpful are balance reactive strategies evoked by unexpected perturbation of balance.

Ineffective balance reactive reactions following unexpected loss of balance is one of the major causes of falls in older adults living in the community. Unexpected loss of balance, such as a slip or a trip, trigger automatic postural responses, which act to restore equilibrium. These balance reactive responses are specific to the size, type and direction of the perturbation. For example, fixed base-of-support strategies (feet remain in place) are used to restore balance by ankle, hip and trunk movements following minor to moderate perturbations. However, in response to larger perturbations, change of base-of-support strategies are used. Recently published systematic reviews found that perturbation training programs are effective for improving balance recovery strategies as well as reducing fall incidence and may even reduce diverse risks of falls and the rate of falls.

Perturbation-Based Balance training (PBBT) is a specific type of balance training where subjects frequently exposed to unannounced balance losses, aimed to evoke and improve balance reactive responses to avoid a fall. Perturbation training intervention programs are conducted by different mechatronic systems that provide external perturbations in standing and walking position in various ways. These training devices were designed to train specifically the change of support i.e., stepping reactions in older adults who were able to stand or walk independently without external support for whole training sessions, usually lasting 20-45 minutes each. Thus, older adults who are unable to walk independently on a treadmill such as pre-frail or frail older adults as well as people with neurological disorders are less able to participate in these training programs. In order to adapt the perturbation training approach for these people, a mechatronic system that provides balance training including perturbations during in-place walking while providing support can be valuable for older individuals.

Thus, there is a need in the art for improved systems and methods for training and enhancing balance control, including measures for preventing falls of subjects in need thereof, which are susceptible to loss of balance.

### SUMMARY OF INVENTION

The following embodiments and aspects thereof are described and illustrated in conjunction with compositions and methods which are meant to be exemplary and illustrative, not limiting in scope. In various embodiments, one or more of the above-described problems have been reduced or eliminated, while other embodiments are directed to other advantages or improvements.

The present invention provides, in some embodiments, a mechatronic in-place walking trainer system capable of providing a subject with unexpected perturbations, for improving balance control of a subject. The system is further capable of providing the subject with feedback for their reactive response to the perturbation, as well as to modify the perturbation scheme based on the subject's response.

In some embodiments, there is provided a perturbed walking training system for improving balance control in a subject, the system comprising:
a movable platform;
a supported in-place walking trainer (SUIT) mounted on the movable platform, the SUIT comprising a first stepper operably connected to a first shaft and a second stepper operably connected to a second shaft;
at least one platform motor configured to control movement of the platform; and
a central control unit,
wherein the system is configured to administer external perturbations to the SUIT at least by moving the platform, thereby inducing balance reactions in the subject.

In some embodiments, the movable platform is mounted on an axis and is configured to be in a fixed state or a floating state. In some embodiments, the system further comprises a platform gear mechanism configured to allow transmission of platform motor rotation with a rotation axis of the platform by one or more ball bearings, thereby allowing rotation and external platform-induced perturbations.

In some embodiments, the first stepper is connected to a first stepper motor controlling movement of the first stepper, and the second stepper is connected to a second stepper motor controlling the movement of the second stepper. In some embodiments, the first stepper and the second stepper are configured to each independently be in a fixed state or in a floating state. In some embodiments, the system further comprises at least one stepper gear mechanism configured to allow transmission of rotation from the first stepper motor and/or the second stepper motor with a rotation axis of the first stepper and/or the second stepper by one or more ball bearings, thereby allowing rotation and the external stepper-induced perturbations of the first stepper and/or the second stepper.

In some embodiments, the external perturbations are platform-induced perturbations and/or stepper-induced perturbations. In some embodiments, the external perturbations are provided in a triangular motion profile (acceleration-deceleration) for each perturbation. In some embodiments, one or more of the provided external perturbations are unexpected.

In some embodiments, the external perturbations are selected from: lateral perturbations (roll, left and right tilt), antero-posterior perturbations (pitch, forward and backward tilt), vertical perturbations, rotations around a vertical axis, and any combination thereof.

In some embodiments, the lateral perturbations have an angle in a range of about 0°-8° to each side, angular velocity in a range of about 0-30 deg/sec, and/or acceleration or declaration in a range of about 0-30 deg/sec².

In some embodiments, the antero-posterior perturbations have an angle in a range of about 0°-8° to each direction, angular velocity in a range of about 0-30 deg/sec, and/or acceleration or declaration in a range of about 0-30 deg/sec².

In some embodiments, the lateral perturbations and/or the antero-posterior perturbations have a frequency in a range of about 1-15 times per minute.

In some embodiments, the vertical perturbations are in a range of about 0-15 cm in each direction, have a velocity in a range of about 0-40 cm/sec, have acceleration or declaration in a range of about 0-40 cm/sec², and/or have a frequency in a range of about 1-15 perturbations/min.

In some embodiments, the rotation perturbations are in a range of about 0°-8° in each direction, have angular velocity in a range of about 0-40 deg/sec, have acceleration or declaration in a range of about 0-40 deg/sec², and/or have a frequency in the range of about 1-15 perturbations/min.

In some embodiments, the first shaft and the second shaft are operably connected to at least one shaft mechanism. In some embodiments, the first shaft and the second shaft are operably connected to a single shaft mechanism which is configured to control resistance of the first shaft and the second shaft. In some embodiments, the first shaft is operably connected to a first shaft mechanism and the second shaft is operably connected to a second shaft mechanism and each of the first and the second shaft mechanisms are configured to control respective resistance of the first and the second shafts such that the first shaft mechanism causes the first shaft to move with a first resistance and the second shaft mechanism causes the second shaft to move with a second resistance. In some embodiments, the first resistance is the same as the second resistance. In some embodiments, the first resistance is different from the second resistance.

In some embodiments, the system further comprises a harness. In some embodiments, the harness is configured to secure the subject during perturbations. In some embodiments, the harness is configured to provide pull perturbations to the subject.

In some embodiments, the system further comprises a motion control system as part of the central control unit. In some embodiments, the system further comprises a motion capture unit. In some embodiments, the motion capture unit comprises one or more video cameras or depth cameras.

In some embodiments, the central control unit is configured to control operation parameters of the motion control unit and/or the motion capture unit.

In some embodiments, the system further comprises a user interface and/or a display.

In some embodiments, the central control unit is further configured to provide a cognitive challenge to the subject.

In some embodiments, the central control unit comprises a processing unit configured to execute a computer program configured to determine performance of the subject during perturbations and/or define further perturbations training sessions.

In some embodiments, the computer program comprises machine learning algorithms.

In some embodiments, the determination of the performance of the subject during perturbations is performed in real time, based at least in part on data related to balance reactive response performance of the subject during perturbations and optionally, during the cognitive challenge. In some embodiments, the defining of further perturbations training sessions is based at least in part on data related to the performance of the subject during a previous perturbation session.

In some embodiments, the training session comprises operating parameters selected from: type of perturbation, maximum acceleration/deceleration of a perturbation, maximum velocity (angular velocity) of a perturbation, magnitude of a perturbation, angle of perturbation, number of perturbation repetitions, the delay time between the perturbations, or any combination thereof.

In some embodiments, the processing unit is configured to provide real-time feedback to the subject regarding reactive balance reaction following a single perturbation or perturbation session.

In some embodiments, the central control unit is configured to allow a subject to determine, select or confirm a training plan and/or control one or more balance exercise parameters.

In some embodiments, the system does not comprise handrails or gripping handles. In some embodiments, the system further comprises adjustable gripping handles. In some embodiments, the gripping handles comprise a heart rate sensor and/or a pressure sensor.

In some embodiments, there is provided a method for training or improving balance control of a subject, the method comprising:
providing one or more unexpected external perturbations to a subject using the system described herein;
detecting a reactive balance response of the subject to the external perturbations based on data acquired by the motion capture unit of the system;
analyzing the detected reactive and proactive balance response of the subject; and
providing feedback to the subject if the balance response is determined to be above a balance response threshold.

In some embodiments, the system further comprises providing a cognitive challenge to the subject and determining a cognitive performance of the subject, based on the response to the cognitive challenge.

In some embodiments, the cognitive challenge is provided in synchronization with an unexpected external perturbation.

In some embodiments, the balance response threshold is customized to the subject.

In some embodiments, the balance response threshold is determined based on calibration and/or previous training sessions.

In some embodiments, the feedback comprises stopping the perturbation and returning the platform to a neutral position.

In some embodiments, In some embodiments, the analysis of the detected balance response and/or cognitive performance is performed by a computer program comprising AI algorithms.

In some embodiments, the computer program is configured to provide feedback to the subject indicative of the performance of the subject in the reactive balance response and/or the cognitive challenge.

In some embodiments, the computer program is further configured to adjust operating parameters of the training session based at least in part on the analyzed reactive balance response.

In some embodiments, the operating parameters comprise: type of perturbation, maximum acceleration/deceleration of a perturbation, maximum velocity (angular velocity) of a perturbation, magnitude of a perturbation, angle of perturbation, number of perturbation repetitions, the delay time between the perturbations, or any combination thereof.

In some embodiments, the computer program is further configured to determine or recommend operating parameters of a following training session and/or a training plan said training plan comprises two or more training sessions.

In some embodiments, there is provided a computer-readable storage medium having stored therein machine learning software, executable by one or more processors for executing the method disclosed herein.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF DRAWINGS

The patent or application file contains at least one drawing executed in color. Copies of this patent or patent application publication with color drawing(s) will be provided by the Office upon request and payment of the necessary fec.

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, optional elements/components and optional stages may be included within dashed boxes.

In the figures:

FIGS. 1A-1B are pictograms of a mechatronic supported in-place walking trainer system, according to some embodiments. FIG. 1A shows a Top view of the system. FIG. 1B. shows a side view of the system.

FIG. 2 is a flowchart of the interaction of parts of the system according to some embodiments, in which the system comprises a single shaft mechanism and optionally two stepper motors.

FIG. 3 is a flowchart of the interaction of parts of the system according to some embodiments, in which the system comprises two shaft mechanism and optionally two stepper motors.

FIGS. 4A-4B are pictograms showing platform-induced perturbations according to some embodiments. FIG. 4A. platform-induced Lateral perturbations. FIG. 4B. platform-induced antero-posterior perturbations.

FIGS. 5A-5B are pictograms showing stepper-induced perturbations according to some embodiments. FIG. 5A. stepper-induced Lateral perturbations. FIG. 5B. stepper-induced antero-posterior perturbations.

FIG. 6 is a pictogram showing a safety harness in some embodiments, in which the safety harness is secured to poles connected to the system.

FIG. 7 is a pictogram showing a safety harness in some embodiments, in which the safety harness is connected to the ceiling.

FIG. 8 is a pictogram showing a harness in some embodiments, in which the harness is secured to a set of pulleys connected to a motor and is configured to provide pull perturbations to the subject.

FIG. 9 is a pictogram showing a harness in some embodiments, in which the harness is secured to the ground and is configured to provide to the subject a force similar to a gravitational force, for practicing in a weightless environment such as a space station.

FIGS. 10A-10B show an exemplary history tab of a user interface, displaying training data of a training session with a right perturbation, according to some embodiments. FIG. 10A. A pictogram showing the position of the subject. FIG. 10B. Graph displaying the training data.

FIGS. 11A-11B show an exemplary history tab of a user interface, displaying training data of a training session with a left perturbation, according to some embodiments. FIG. 11A. A pictogram showing the position of the subject. FIG. 11B. Graph displaying the training data.

FIGS. 12A-12B show an exemplary history tab of a user interface, displaying training data of a training session with a backwards perturbation, according to some embodiments. FIG. 12A. A pictogram showing the position of the subject. FIG. 12B. Graph displaying the training data.

### DETAILED DESCRIPTION OF THE INVENTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

A major health problem in elderly people is falls, which may lead to serious injuries and even death. Ineffective balance reactive reactions are one of the major causes of falls in elderly people. Existing balance training programs require standing or walking without support for periods of 20-45 minutes, which is not suitable for many elderly people suffering from various conditions such as neurological problems or osteoarthritis, or who are simply too weak to stand without support. Further, elderly individuals with severe lower limb osteoarthritis are unable to practice their balance due to the ground reaction impact forces that are induced during training such as walking and performing high velocity stepping responses.

Supported in-place walking systems, such as a stepper trainer or an elliptical trainer, offer advantages over other training tools, since its constant double-limb support diminishes recurring high-impact plantar forces while allowing exercise in a functional, upright posture. As opposed to bicycle trainers, supported in-place walking, such as on an elliptical trainer, is a lower-extremity rhythmic task with reflex modulation similar to walking and most likely involving similar neural circuitry, which make such a system a useful tool for simulating real-life situations.

The present invention is directed to a mechatronic supported in-place walking perturbation-based system (or a perturbed walking training system), which is designed to train an individual for proactive and reactive legs, hip, trunk, and arm balance responses. The training is done by providing expected or unexpected (unannounced) multidirectional tilt perturbations during supported in-place walking without holding the handrails.

The training is based on motor learning principles that refers to the human internal processes associated with practice of a particular movement that leads to relatively permanent changes in the capability to respond. The motor learning process improves with the practice of many repetitions of motor performance, leading to the increased capability to perform the desired action. since random order of perturbations is known to result in better motor learning, the practice includes varied perturbations in a random order. The training is directed to performing effective balance reactive responses with arms, trunk, head and arms in order to recover balance after a perturbation.

The system is also capable of identifying the subject's balance reactive responses to the unexpected perturbations by using an artificial intelligence (AI)-based software. In response to the subject's balance responses, the AI system is capable of modifying the training level, for example, by increasing the level of training difficulty if the subject is successful in coping with the existing level. As a result, the subject receives real time feedback to their responses.

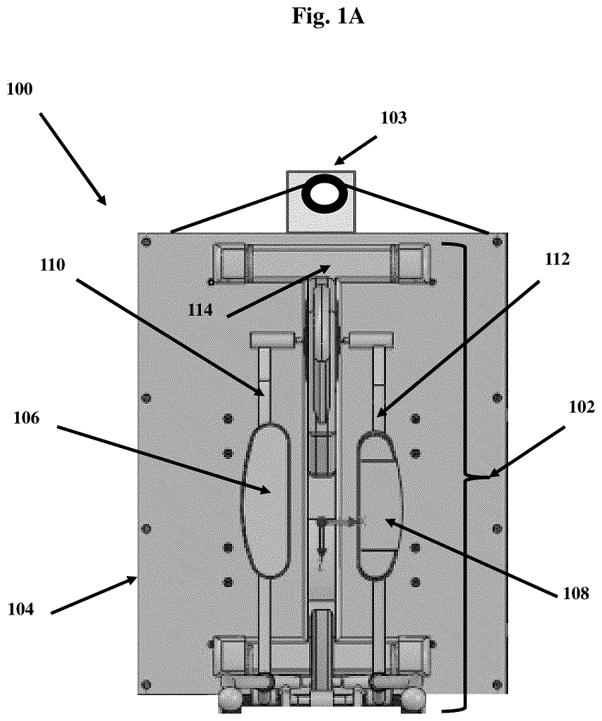

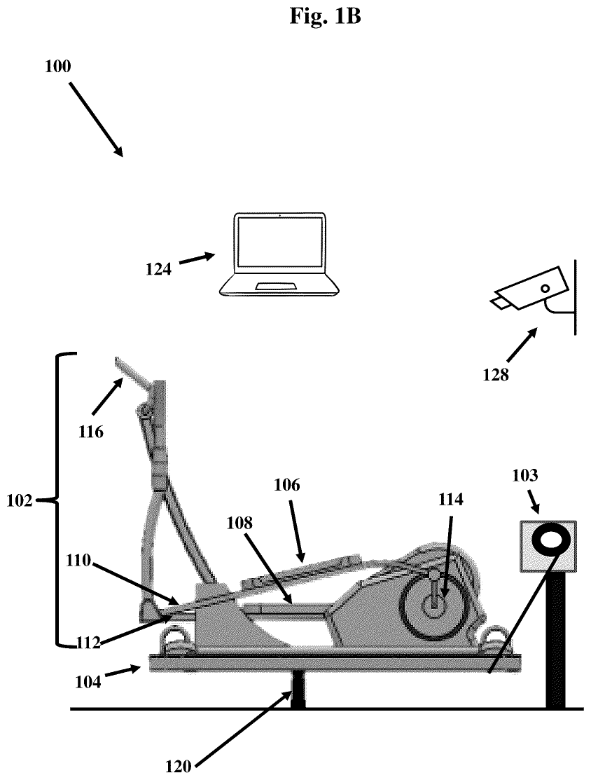

Reference is made to FIGS. 1A and 1B, which show a pictogram of the mechatronic supported in-place walking trainer system, according to some embodiments. As seen from FIGS. 1A and 1B, the position on the subject when training on the system is a standing position, wherein the trainer simulates walking (in-place walking). Shown in FIG. 1A is a top view of exemplified system (100), which includes supported in-place walking trainer (SUIT) (102), situated/mounted on/attached to a movable platform 104. Movable platform (104) is configured to provide various types of external and internal perturbations as further detailed below, for example by being moved/tilted using gears and gear mechanisms powered by platform motor (103) attached thereto. As shown in FIG. 1B, the motor may be controlled by a central control unit (124).

In some embodiments, the system is a perturbed walking training system for improving balance control in a subject, the system comprising:
a movable platform (104);
a supported in-place walking trainer (SUIT) (102) mounted on the movable platform (104), the SUIT comprising a first stepper (106) operably connected to a first shaft (110) and a second stepper (108) operably connected to a second shaft (112);

at least one platform motor (103) configured to control movement of the platform (104); and
a central control unit (124),
   wherein the system is configured to administer external perturbations to the SUIT (102) at least by moving the platform (104), thereby inducing balance reactions in the subject.

The term “mechatronic”, as used herein, relates to a system which includes mechanical, electronic, and computing elements.

The term “movable platform”, as used herein, relates to a surface upon which the system is mounted, and that may be moved. The moving of the platform is caused by a motor that is connected to the platform, e.g., by a gear system. The platform may be moved in various directions, as disclosed hereinbelow.

The term “in-place walking training system” or “in-place walking trainer”, as used herein, relates to a training system which simulates walking, but on a stationary machine, such as a treadmill, a stepper trainer, and an elliptical trainer.

The term “supported in-place walking training system” or “supported in-place walking trainer” (SUIT), as used herein, relates to an in-place walking training system in which each leg is independently supported by a stepper, such that during the walking movement the feet are not raised from the stepper (in contrast to a treadmill) but are moving the stepper with the movement of the feet. Such systems, e.g., an elliptical trainer or a stepper, have the advantage of preventing the impact received from the ground during ground walking, or while walking on a treadmill.

The term “stepper”, as used herein, relates to a place onto which the subject puts his foot. Each foot is placed on a separate stepper, and thus the system comprises two steppers. During in-place walking, the subject pushes on the steppers with his feet, such that the feet do not leave the steppers. Each stepper may be fixed, movable, or floating, as explained in more detail below. When referring to the machine which is called “stepper”, the term “stepper trainer” is used.

The phrase “X operably connected to Y”, as used herein, means that X and Y work together. For example, X is connected to Y in such a way that allows Y to cause movement of X, or vice versa. For example, If Y is a motor, its function is capable of causing X to move. X may be directly connected to Y, or X may be connected to Y via additional elements.

The term “shaft” as used herein, relates to a long part via which a stepper is connected to the system. The stepper may be directly connected to the shaft, and move together with the shaft, or the stepper may be connected to the shaft via an axis, thereby having some degrees of freedom with respect to the shaft.

According to some embodiments, the movable platform is an open iron frame, for example, 152-cm long and 64-cm wide, located within another stationary iron frame that are interconnected by two ball bearings allowing tilt motion in lateral directions.

In some embodiments, the system further comprises a platform gear mechanism configured to allow transmission of platform motor rotation with a rotation axis of the platform by one or more ball bearings, thereby allowing rotation and external perturbations of the platform. In some embodiments, the gear mechanisms combine the platform motor rotation with the platform rotation axis by two ball bearings, one on each side of the platform, allowing the platform rotation and hence the platform-induced balance perturbation tilts.

In some embodiments, to link the rotation of the motors to the tilt of the platform, a four-bar linkage mechanism may be attached to the output shafts of the gear.

The SUIT system (102) is mounted on the movable platform (104) and secured by any suitable element such as, for example, by screws. the movable platform frame may be connected from both ends (back and front) to two ball bearings. The front ball bearing connects to a gear mechanism and the platform motor.

According to some embodiments, the SUIT may be mounted on, attached to, fixed to, or associated with the movable platform, in a reversible or non-reversible manner.

As further shown in FIG. 1A, system (100) further includes two steppers, (106) and (108), which are part of the SUIT system (102), and on which the subject places his/her feet when standing on the SUIT (one foot on one stepper). Stepper (106) is connected to the SUIT via a shaft (110), and stepper (108) is connected to the SUIT via shaft (112).

The SUIT (102) may be any training system which simulates supported in-place walking, where the feet are constantly supported by steppers. Examples for available such systems include an elliptical trainer and a stepper trainer. Accordingly, in some embodiments, the SUIT is an elliptical trainer or a stepper trainer. In some embodiments, the SUIT is an elliptical trainer. In some embodiments, the SUIT is a stepper trainer.

In some embodiments, the system comprises a movable platform, an elliptical trainer mounted on the movable platform, at least one platform motor configured to control movement of the platform, and a central control unit.

As further shown in FIG. 1A, system (100) further includes shaft mechanism (114), which is operably connected to shafts (110) and (112). Accordingly, in some embodiments, the first shaft (110) and the second shaft (112) are operably connected to at least one shaft mechanism (114).

FIG. 1B shows a side view of system (100). In the embodiment exemplified in FIG. 1B, the movable platform is placed on an axis (120), and transitions between two states: a “fixed state”, under which the movable platform can provide external perturbations (i.e., the movement thereof is provided by the system), and a “non-fixed” or “floating” state, under which the platform is non-stable (i.e., it is not stationary/fixed), which provides “intrinsic” perturbation, by forcing the subject to balance him/herself on the platform.

With regard to the steppers, in some embodiments, each stepper (106), (108) is connected to the respective shaft (110), (112) in a rigid way, i.e., each stepper (106), (108) is moved by the movement of the respective shaft (110), (112) and is not capable of moving independently from the respective shaft.

Alternatively, in some embodiments, similar to the platform mentioned above and as detailed hereinbelow, at least one of steppers (106) and (108) may be connected to the respective shaft (110) and/or (112) by an axis, and transition between two states: a “fixed state”, in which the stepper (106) and/or (108) can provide external perturbations, as explained below in more detail, and a “non-fixed” or “floating” state, in which the stepper is non-stable (i.e., it is not stationary/fixed), which provides “intrinsic” perturbation, by forcing the subject to balance him/herself on the steppers. In some embodiments, both steppers (106) and (108) are each connected to their respective shaft (110) or (112) by an axis and can transition, together or independently of each other, between a fixed state and a floating state with respect to the respective axis. Accordingly, in some embodiments, one of the steppers (106) and (108) may be at a fixed state while the other stepper is at a floating state. In some embodiments, both of the steppers (106) and (108) may be at a fixed state or both at a floating state.

As further shown in FIG. 1B, system (100) optionally includes gripping handles (handrails, or handlebar) (116), which may be used to assist the subject in positioning or in resting. In some embodiments, the gripping handles are not used during a training session.

As shown in FIG. 1B, according to some embodiments, the system (100) further includes a motion capture unit (128), which includes one or more motion capturing devices (such as video cameras or depth cameras), which is configured to detect motion of the subject, in particular, during perturbation. In some embodiments, the motion capture camera may be mounted at a horizontal plane at a height of about 1 m-1.8 m behind the trainee's standing position for the best motion capture of the trunk and arms reactions.

In some embodiments, the system further includes a central control unit (124), which may include one or more displays, and/or processors, which are configured to control operation of the system, obtain data from the motion capture unit (128), analyze data related thereto, provide real time feedback to the subject and/or trainer, assess subject performance, determine or suggest a training session or training program, provide, present and/or assess cognitive tasks to subject, and the like, or combinations thereof.

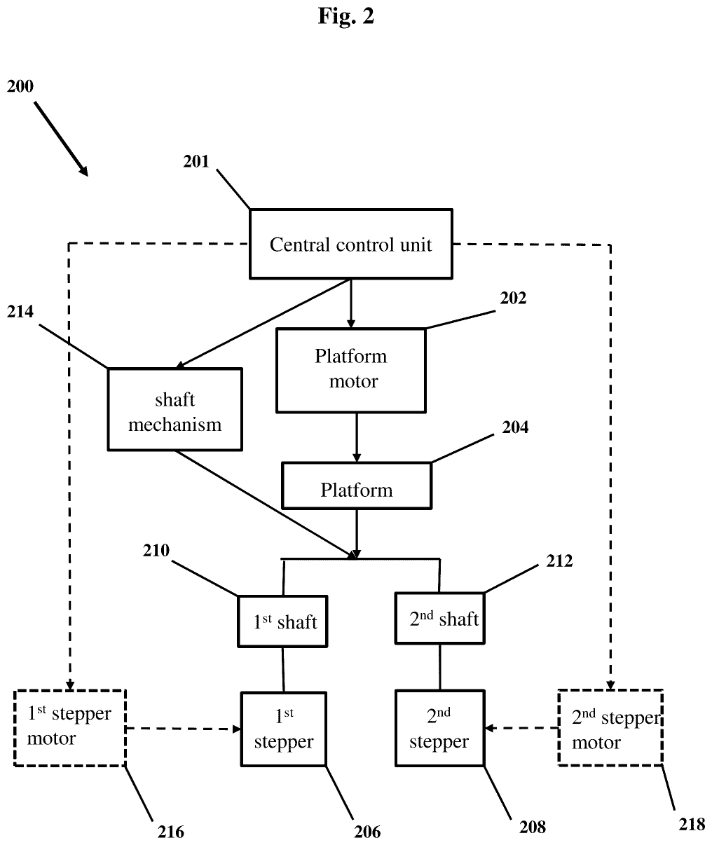

Reference is made to FIG. 2, which is a flowchart showing the interaction between various parts of the system, according to some embodiments. As shown in FIG. 2, the exemplified system (200) includes a central control unit (201), which controls movement of the various elements of the system. As shown, the central control unit (201) controls the platform motor (202), which can move the movable platform (204) as explained above, to cause perturbations of the SUIT. The movement of the platform (204) affects the first and the second shafts (210) and (212), which are connected to platform (204), thereby also affecting the first and the second stepper (206) and (208) (which are operably connected to shafts (210) and (212), respectively), thereby causing perturbation to the subject which stands on the steppers.

As further shown in FIG. 2, the central control unit (201) further controls shaft mechanism (214), which is operably connected to the first shaft (210) and to the second shaft (212). The shaft mechanism allows the movement of the shafts (210) and (212), with the respective steppers (206) and (208). The shaft mechanism is configured to allow movement of the shafts connected thereto, which is initiated by the subject pushing of the steppers. In some embodiments, the shaft mechanism is capable of controlling the speed or the difficulty of movement of the shafts, e.g., by providing resistance to the movement initiated by the subject.

In some embodiments, the first shaft (210) and the second shaft (212) are operably connected to a single shaft mechanism (214) which is configured to control speed or the difficulty of movement of the first shaft (210) and the second shaft (212), e.g., by providing resistance to the movement of the shafts. In the exemplified embodiment, the steppers (206) and (208) move synchronously, with the same resistance.

As explained above with respect to FIG. 1 for steppers (106) and (108), in some embodiments, each stepper (206) and (208) is connected to the respective shaft (210) or (212) in a rigid way, i.e., each stepper (206) and (208) moves together with its respective shaft (210) or (212).

In some embodiments, at least one of steppers (206) and/or (208) may be connected to its respective shaft (210) or (212) by an axis, and transition between a fixed state and a floating state with respect to the axis.

Additionally, as shown in FIG. 2, the system optionally includes two stepper motors, stepper motor (216), operably connected to first stepper (206), and stepper motor (218), operably connected to first stepper (208). When steppers (206) and (208) are connected to their respective shafts (210) and (212) via axes and are in a fixed state, motors (216) and (218) can cause movement of steppers (206) and (208), respectively, in a similar way to that described in FIG. 1 for platform (104), to thereby cause ankle-specific perturbations to the subject standing on the steppers, as described in more details below. The stepper motor may be any suitable of motors, such as a rotary motor, a brushed motor, a brushless motor, with gear or as a direct drive. The motor may be controlled as a servo motor using an encoder for measuring the angle.

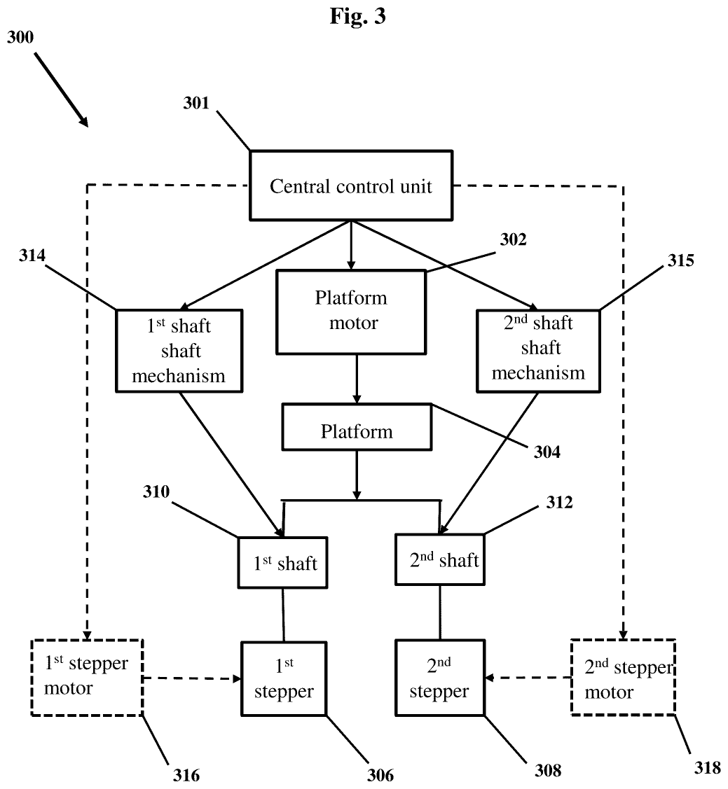

Reference is made to FIG. 3 which is a flowchart showing the interaction between various parts of the system, according to some embodiments. Similar to FIG. 2, the exemplified system (300) includes a central control unit (301), which controls movement of the various elements of the system. As shown, the central control unit (301) controls the platform motor (302), which can move the movable platform (304) as explained above, to cause perturbations of the SUIT. The movement of the platform (304) affects the first and the second shafts (310) and (312), which are connected to platform (304), thereby also affecting the first and the second stepper (306) and (308), thereby causing perturbation to the subject which stands on the steppers.

As further shown in FIG. 3, the central control unit (301) further controls first shaft mechanism (314) and second shaft mechanism (315). First shaft mechanism (314) is operably connected to the first shaft (310) and controls the speed or the difficulty of its movement, e.g., by providing resistance to the first shaft movement, thereby also controlling the movement of the first stepper (306), connected to the first shaft (310). Second shaft mechanism (315) is operably connected to the second shaft (312) and controls the speed or the difficulty of its movement, e.g., by providing resistance to the shaft movement, thereby also controlling the movement of the second stepper (308), connected to the second shaft (312). Accordingly, in some embodiments, the two shafts are each separately connected to a different shaft mechanism, for example, first shaft (310) is operably connected to a first shaft mechanism (314) and the second shaft (312) is operably connected to a second shaft mechanism (315), and each of the first and the second shaft mechanisms are configured to provide resistance to first and the second shafts such that the first shaft mechanism (314) causes the first shaft (310) to move with a first resistance and the second shaft mechanism (315) causes the second shaft (312) to move with a second resistance. In some embodiments, the first resistance is the same as the second resistance. In some embodiments, the first resistance is different from the second resistance.

Such a mechanism which provides a different resistance to the movement of each leg may be useful in improving situations in subject who have an unbalanced gait, limping, or some other difference in strength between feet, which require more focused work on one leg compared to the other.

As explained above with respect to FIG. 1 for steppers (106) and (108), in some embodiments, each stepper (306), (308) is connected to the respective shaft (310), (312) in a rigid way, i.e., each stepper (306), (308) moves together with the respective shaft (310), (312).

In some embodiments, at least one of steppers (306) and (308) may be connected to the respective shaft (310) or (312) by an axis, and transition between a fixed state and a floating state with respect to the axis, as explained above.

As shown in in the exemplary system demonstrated in FIG. 3, the system optionally includes two stepper motors, stepper motor (316), operably connected to first stepper (306), and stepper motor (318), operably connected to first stepper (308). When steppers (306) and (308) are connected to their respective shafts (310) and (312) via axes and are in a fixed state, motors (316) and (318) can cause movement of steppers (306) and (308), respectively, in a similar way to that described in FIG. 1 for platform (104), to thereby cause ankle-specific perturbations to the subject standing on the steppers. The stepper motors may be any type of suitable motors, such as a rotary motor, a brushed motor, a brushless motor, with gear or as a direct drive. The motor may be controlled as a servo motor using an encoder for measuring the angle.

Accordingly, in some embodiments, the first stepper is connected to a first stepper motor controlling movement of the first stepper, and the second stepper is connected to a second stepper motor controlling the movement of second stepper.

In some embodiments, the system further comprises at least one stepper gear mechanism configured to allow transmission of rotation from the first stepper motor and/or the second stepper motor with a rotation axis of the first stepper and/or the second stepper by one or more ball bearings, thereby allowing rotation and the external platform perturbations of the first stepper and/or the second stepper. In some embodiments, the stepper gear mechanisms combine the stepper motor rotation with the stepper rotation axis by two ball bearings, one on each side of the stepper, allowing the stepper rotation and hence the stepper-induced balance perturbation tilts.

The invention comprises various motors. At least one platform motor is operably connected to the platform and is capable of causing the platform to move in various directions, as explained below in more detail. Shaft motor(s) are operably connected to shaft(s) and generally provide or control resistance of the shaft(s) and therefore the steppers. One shaft motor may be operably connected to one shaft, or one shaft motor may be operably connected to both shafts. Stepper motor(s) are operably connected to stepper(s) and are capable of causing the stepper(s) to move in various directions, similar to the platform, as explained below in more detail.

In some embodiments, the motors may be rotary electrical motors such as direct current (DC) motors. Any of the motors may be brushed DC motors. Any of the motors may be servo motors. In some embodiments, any of the motors is selected form a rotary motor, a brushed motor, a brushless motor, with gear or as a direct drive. The motor may be controlled as a servo motor using an encoder for measuring the angle.

In some embodiments, the platform is operably connected to two platform motors. In some embodiments, the platform motors are brushed DC motors. In some embodiments, the platform is operably connected to two 24V DC brushed motors. In some embodiments, the two DC platform motors have a power rating of 200W. In some embodiments, the motors have a maximum speed of 105 degrees per second (for example, 90-130 degrees/s) and peak torque of 25 Nm (for example, 15-35 Nm).

In some embodiments, any of the gear mechanisms of the system are worm gearboxes such as NMRV-type gears. In some embodiments, the gear ratio of the gears of the system is about 1:5 to 1:50. In some embodiments, the gear ratio of the gears of the system is about 1:50.

In some embodiments, any of the gear mechanisms may include a motor and a set of gears and transmissions, configured to move the movable platform and/or the steppers to thereby provide perturbations to the subject. The gear mechanism may include a small external gear, a cylinder, a motor chain, an internal transmission system, and a large external gear, wherein the small and the large external gears are connected by a motor chain. The cylinder may be welded to the large external gear.

The system is capable of causing perturbations to the subject by moving different elements of the system, such as the platform and/or the steppers. In some embodiments, the perturbations are caused by movement of the platform, and are termed herein “platform-induced perturbations”. In some embodiments, the perturbations are caused by movement of the stepper(s), and are termed herein “stepper-induced perturbations”. In some embodiments, the system provides both platform-induced perturbations and stepper-induced perturbations. In some embodiments, the system provides only platform-induced perturbations. In some embodiments, the system provides only stepper-induced perturbations. In some embodiments, the system provides both platform-induced perturbations and stepper-induced perturbations.

The term “perturbation” is used herein interchangeably with “balance perturbations” and means interference, i.e., interference with the subject's walking. Perturbation Balance Training is a specific type of balance training where participants repeatedly experience unannounced balance loss and need to execute balance reactive responses to avoid a fall. External, or extrinsic, perturbations are provided by the system and include movements of the platform and/or of the steppers in various directions, as detailed hereinbelow. Internal, or intrinsic, perturbations may be caused when the platform or the steppers are in a floating mode, allowing free movement of the subject. Unexpected, or unannounced, perturbations are caused by the system in a random manner, intended to surprise the subject. Block perturbations are scheduled, expected (announced) perturbations at a fixed frequency with fixed time intervals, where the trainee is made aware of the direction and timing of the perturbations a few seconds, such as 5 seconds, ahead of the perturbation.

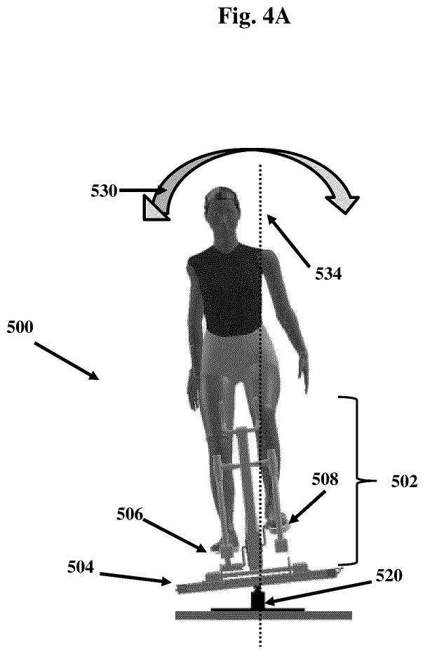

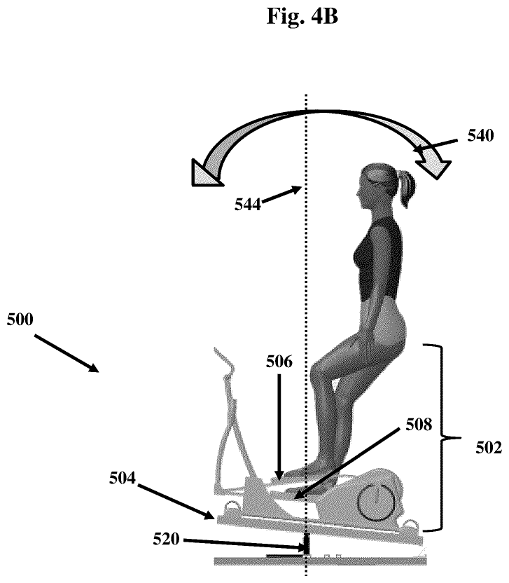

Reference is now made to FIGS. 4A-4B, which are pictograms showing various external platform-induced perturbations in an exemplary training system, according to some embodiments. As shown in FIG. 4A, exemplary system (500) includes at least the SUIT system (502) which includes steppers (506) and (508), mounted on movable platform (504). Further shown is axis (520), on which the platform (504) is mounted. Illustrated in FIG. 4A are lateral (left-right) platform-induced perturbations (530) (relative to axis (534)).

Reference is made to FIG. 4B which illustrates antero-posterior (front-back) platform-induced perturbations (540) (relative to axis (544)) in exemplary system (500).

According to some embodiments, the system may provide tilt right-left platform-induced perturbation (roll). According to some embodiments, the system may provide tilt front-back platform-induced perturbation (pitch). In some embodiments, the system may provide combinations of roll and pitch perturbations (such as a diagonal direction). In some embodiments, for the tilt perturbations (roll and pitch), the maximum tilt angle (each side) in the range of about 0-25°, about 0-15°, or about of 0-8°, such as about 8°, with acceleration and deceleration in the range of 20-40 deg/sec² and maximum angular velocity in the range of about 20-40 deg/sec (for example, maximum acceleration and deceleration of 30 deg/sec² and maximum angular velocity of 30 deg/s), and a perturbation frequency of about 1-15 perturbations/minute.

In some embodiments, the system may provide rotational platform-induced perturbations. In some embodiments, the system may provide vertical (up-down) perturbations.

In some embodiments, the external platform-induced perturbations are selected from: lateral perturbations (roll, left and right tilt), antero-posterior perturbations (pitch, forward and backward tilt), vertical perturbations (up-down), rotations around a vertical axis, and any combination thereof. In some embodiments, the platform-induced perturbations are tilt perturbations, i.e., roll and pitch perturbations and combinations thereof.

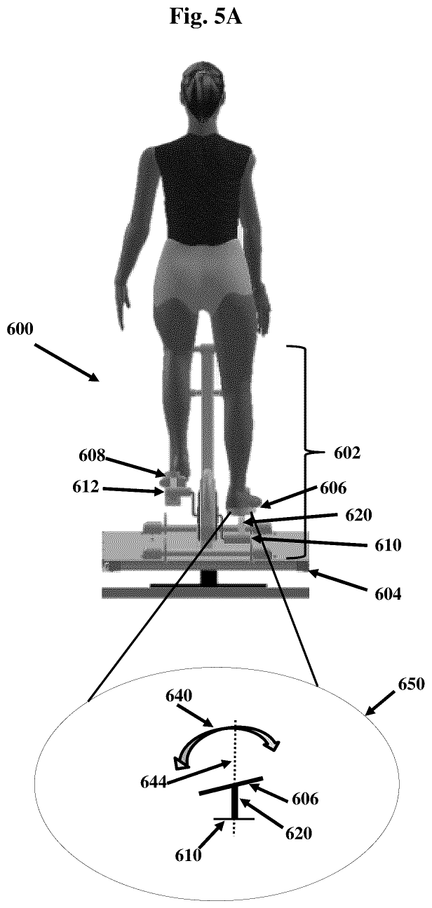

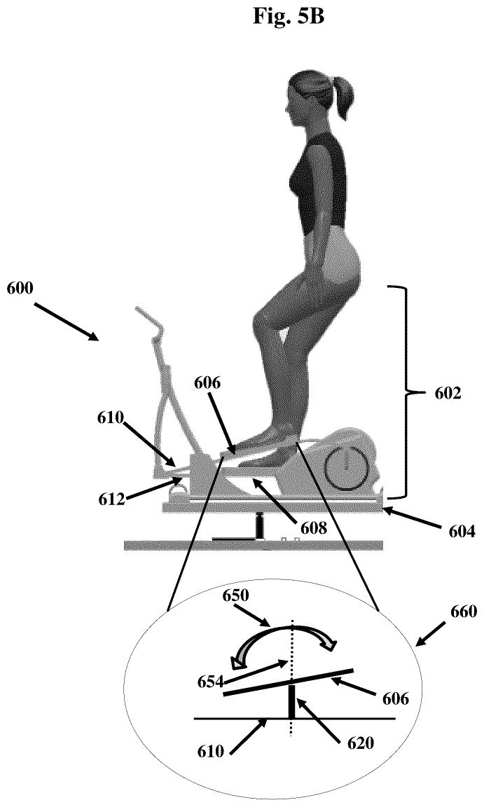

Reference is now made to FIGS. 5A-5B, which are pictograms showing various external stepper-induced perturbations in an exemplary training system, according to some embodiments. As shown in FIG. 5A, exemplary system (600) includes at least SUIT system (602) which includes steppers (606) and (608) operably connected to shafts (610) and (612), respectively, and the system is mounted on movable platform (604). Illustrated in FIG. 5A are lateral (left-right) stepper-induced perturbations (640) of stepper (606), relative to axis (644), as shown in the blow-up diagram (650). Although the stepper-induced perturbations (640) are shown only for stepper (606), a similar structure and function is intended for stepper (608). To facilitate the perturbations, stepper (606) is connected to shaft (610) via axis (620). As described in FIGS. 2 and 3, the steppers may be operably connected to a motor, which may control external perturbations when the steppers are in a fixed state with respect to their respective axes.

Reference is made to FIG. 5B which illustrates antero-posterior (front-back) stepper-induced perturbations (650) (relative to axis (654)) of stepper (606) in exemplary system (600), as shown in blow-up diagram (660). As shown, stepper (606) is connected to shaft (610) via axis (620), to facilitate the perturbations. Although the stepper-induced perturbations (650) are shown only for stepper (606), a similar structure and function is intended for stepper (608). As described in FIGS. 2 and 3, the steppers may be operably connected to a motor, which may control external perturbations when the steppers are in a fixed state with respect to their respective axes.

According to some embodiments, the system may provide tilt right-left stepper-induced perturbation (roll). According to some embodiments, the system may provide tilt front-back stepper-induced perturbation (pitch). In some embodiments, the system may provide combinations of roll and pitch (such as a diagonal direction). In some embodiments, for the tilt perturbations (roll and pitch), the maximum tilt angle (each side) in the range of about 0-25°, about 0-15°, or about of 0-8°, such as about 8°, with acceleration and deceleration in the range of 20-40 deg/sec² and maximum angular velocity in the range of about 20-40 deg/sec (for example, maximum acceleration and deceleration of 30 deg/sec² and maximum angular velocity of 30 deg/s), and a perturbation frequency of about 1-15 perturbations/minute.

In some embodiments, the system may provide rotational stepper-induced perturbations. In some embodiments, the system may provide vertical (up-down) perturbations.

In some embodiments, the external stepper-induced perturbations are selected from: lateral perturbations (roll, left and right tilt), antero-posterior perturbations (pitch, forward and backward tilt), vertical perturbations (up-down), rotations around a vertical axis, and any combination thereof. In some embodiments, the perturbations are tilt perturbations, i.e., roll and pitch perturbations and combinations thereof. In some embodiments, the stepper-induced perturbations are tilt perturbations, i.e., roll and pitch perturbations and combinations thereof.

In some embodiments, the vertical perturbations (induced by platform or stepper) are in a range of about 0-15 cm in each direction, have a velocity in a range of about 0-40 cm/sec, have acceleration or declaration in a range of about 0-40 cm/sec², and/or have a frequency in a range of about 1-15 perturbations/min.

In some embodiments, the rotational perturbations (induced by platform or stepper) are in a range of about 0-8 degrees in each direction, have angular velocity in a range of about 0-40 deg/sec, have acceleration or declaration in a range of about 0-40 deg/sec², and/or have a frequency in the range of about 1-15 perturbations/min.

In some embodiments, the system further comprises a motion control system, which is optionally part of the central control unit. The system may further comprise a motion capture unit, which may include any type of video camera or depth camera, such as, for example, a ZED 2™ from Stereolabs or a Microsoft Kinect™ system, Intel RealSense™ depth camera, webcams, smartphone cameras, and the like).

Any of the motors may be controlled by the motion control system and optionally by the motion capture unit. Both the motion control system and the motion capture unit may be controlled by a main processing unit such as the central control unit executing a set of instructions (i.e., a computer program). In some embodiments, the computer program may be executed on a host personal computer (PC) that may also serve as a user interface. By the computer program command, the motion control system can direct the motor rotation based on a programmed training plan, which is usually that of a triangular motion profile for each perturbation (acceleration-deceleration). The computer program may allow the subject or a trainer to determine the training plan and control one or more of the balance exercise parameters, such as, for example, but not limited to: maximum acceleration/deceleration, maximum angular velocity, angle of perturbation, number of right/left perturbation repetitions, the delay time between the perturbations, and the like, or any combination thereof. In some embodiments, the computer program may also allow controlling a motion capture system/unit (such as, a video camera, high-definition video camera, depth video camera, and the like) that can provide real-time feedback as to the subject's balance reaction following a perturbation.

In some embodiments, once unexpected balance perturbation is provided, when an appropriate reactive balance reaction is detected by the motion capture unit, configurable by the computer program, or by a trainer (also referred to as health care provider, therapist), the movable platform and/or steppers rotation (the perturbation) is stopped, and the motor(s) return the system to its original (vertical) position (its neutral/zero position) by motor counter-rotation. In addition, the program may be configured to save/store a file that logs the exercise(s) performed, for post-training analysis.

According to some embodiments, the system may be used to implement motor learning of balance. Motor learning refers to the human internal processes associated with practice a particular movement that leads to relatively permanent changes in the capability for responding. Motor learning process improves with practice many repetitions of motor performance, leading to improvement in the person's capability in producing the desired action. Varied practice in random order results in better motor learning. In some embodiments, during a customized training program, the desired result is for the subject to perform an effective reactive balance reaction with the trunk, upper body and arms, as well as leg musculature to recover their balance from a perturbation during walking.

Accordingly, in some embodiments, the system, utilizing its computer program and motion control units, is used to expose the subject to repeated random unexpected balance perturbations by tilting the movable platform (including the SUIT and the subject) and/or the steppers repeatedly to varied certain programmed tilt angles, so the patient may learn better how to recover their balance more efficiently along a training session and at whole training course. For even more increasing the subject's motor learning process of acquiring effective reactive balance reactions, the motion capture system monitors the patient's whole-body joints, and following a perturbation, detects the subject's reactive balance reactions and determines whether the response was effectively enough. When an effective balance reaction is performed, the motor control system stops automatically the perturbation and returns immediately the system to its neutral/vertical position (0°). This immediate real-time balance response feedback provides the subject with an implicit cue for successful reactive balance response and gives best possible motor learning implementation.

According to some embodiments, in addition to the external perturbations provided by various motors of the system (e.g., the platform motors and the stepper motors), internal self-induced perturbations may also be provided by the system. According to some embodiments, perturbations may be provided in two forms, “internal” and “external” balance perturbations. As detailed above, the system is configured to provide external machine-induced programmed announced or unannounced lateral perturbations. Additionally, the system may be configured to provide internal self-induced perturbations, for example, during walking on an unstable “floating” movable platform and/or steppers. As also indicated above, in some embodiments, the movable platform and/or steppers may transition between two states/modes: fixed state (whereby it is configured to be moved by the motion control unit and provide external perturbations) and floating (non-fixed) state, in which the platform and/or steppers may be slightly unstable, allowing self-induced tilting (internal perturbations).

The platform and the steppers may be independently in a fixed or in a floating state. In some embodiments, the platform is in a floating state while the steppers are in a fixed state and vice versa. In some embodiments, the platform and the steppers are in a fixed state at the same time. In some embodiments, the platform and the steppers are in a floating state at the same time.

According to some embodiments, in the time interval between two consecutive external perturbations, the movable platform and/or the steppers may be in a fixed mode/state or in the “floating” mode/state, where it can similarly to a surfboard floating on the water and is subjected to the forces exerted on it by the subject during walking. According to some embodiments, this unstable mode/state may be programmed by the user for the time interval between the external perturbations. According to some embodiments, the internal self-induced perturbations may thus be provided by the unfixed (unstable, floating mode) of the movable platform of the system. According to some embodiments, such self-induced perturbations mimic or simulate outdoor bicycling, and can be part of a proactive balance control training. According to some embodiments, such internal perturbations may be included for advanced subjects. According to some embodiments, during the unfixed “floating” mode the motor may be released (i.e., at least a portion of the gear mechanism not engaged with the movable platform), for example, in the time interval between the external perturbations.

According to some embodiments, when calibrating the system, a customized calibration phase may be performed in the same fixed or unfixed floating state, as the one expected to be utilized during the training. In some embodiments, the fixed mode/state is when the system is locked/fixed vertically and used as a regular stationary unit. In some embodiments, the “floating” mode is when the movable platform and/or the steppers are unfixed and unstable, floating like a surfboard and is subjected to the forces acting upon it by the subject.

According to some embodiments, the steppers may be configured to monitor various parameters, such as, for example, but not limited to: walking time, walking distance, walking resistance, determine walking intensity based on distance, heart rate, and walking load, and the like, or any combinations thereof. Each possibility is a separate embodiment. In some embodiments, the steppers may be configured to monitor various walking-related parameters during perturbation training and/or cognitive training. In some embodiments, the speed, resistance, position and/or height of the steppers may be adjustable automatically or manually, e.g., by adjusting the length of the axis which connects the steppers to their respective shafts. In some embodiments, the height of the steppers-shafts axes are in the range of about 2-20 cm.

According to some embodiments, the system may include gripping handles, or handrails. In some embodiments, the gripping handles may be detachable and adjustable according to, for example, the height of the subject. According to some embodiments, grip handles may be used for the subject's positioning, and also be used by those who afraid of hands-free walking (for example, at the beginning of the training session) or whose initial balance ability level is too low for a hands-free walking. In some embodiments, this level of training represents little actual challenge to the postural control system. The goal of the training at this level is mainly directed towards a cognitive understanding of the exercises and an improvement of self-confidence for subjects. Nevertheless, the subject is required/asked to perform the training with no or minimal external support (i.e. without holding the handles). According to some embodiments, the grip handles may further be used for heart rate monitoring. According to some embodiments, pressure sensors may be located on the grip handles. The pressure sensors may be configured to monitor the hands use for holding the handles during training, which can be used as a measure of success in training (for example, hands-free walking of 80% of the training time may be required to advance to the next level). In some embodiments, the pressure sensors may further be used for creating training session which include combined training intervals with and without hands gripping.

According to some embodiments, the system may include a communication unit. The communication unit may be configured for wired communication or wireless communication (using, for example, a cellular network, Wi-Fi and/or Bluetooth). According to some embodiments, the communication unit may allow communication with one or more servers, remote server(s), remote control station, other training units, and the like. In some embodiments, the communication unit allow the transfer or sharing of information, for example to and from servers, to and from other stimulation systems, to and from remote trainers' units, to and from remote central control units, and the like. In some embodiments, the communication unit is functionally and/or physically associated with the control unit.

According to some embodiments, the system may further allow or be utilized to provide training assessment. According to some embodiments, the assessment sessions may be used to enable the user/subject to follow and monitor his/her reactive balance, functional balance and/or cognitive progression after the balance perturbation training program (optionally combined with cognitive tasks, as detailed herein).

According to some embodiments, the subject's balance performance assessment can be performed in various forms, including, for example, by a reactive balance examination on the dedicated movable platform (i.e., the ability to control the center of mass (COM) motion is assessed—lower center-of-mass movement is indicative of better reactive balance ability); or by rotating the motion capture unit into the room space and performing a functional balance examination in the home environment (including, for example, walking task while gait analysis is assessed, single leg stance time). In some embodiments, such assessment options may last about 2-30 minutes (for example, 15 minutes), and the subject is instructed to follow the instructions presented on the display by the system control unit. In some embodiments, the score of the assessment session may be presented on the display (screen) and optionally stored in a memory. In some embodiments, the reactive balance score and/or functional balance score may be used by the computer program of the system (in particular, utilizing artificial intelligence algorithms, as detailed herein), to adjust future training sessions.

According to some embodiments, the system is further configured to provide various types of cognitive challenges to a user, to be performed along with the perturbations. According to some embodiments, the cognitive concurrent tasks may be displayed on the user screen and may be provided by the processing unit during balance perturbation training while hands-free walking. In some embodiments, concurrent cognitive visual tasks may be provided/included to distract the subject, thus, facilitating implicit learning and automatization of reactive balance responses, similar to everyday situations where balance is lost unexpectedly. According to some embodiments, the level and/or type of the cognitive task may be adjusted according to the user physical and/or cognitive ability, thereby allowing a customized training program.

In some exemplary embodiments, the user may execute the cognitive tasks displayed on the screen. In some exemplary embodiments, the cognitive tasks may include various types of tasks, such as, for example, but not limited to: the differences between two pictures, find the odds one out, identify a world location, perform colored Stroop test, and the like, or any combination thereof. In some embodiments, such session may last for about 5-60 minutes (for example, about 15 minutes). In some embodiments, the number of correct answers, memory capability and response time for answering may be assessed and used to provide a cognitive score for a specific assessment session.

According to some embodiments, various types of cognitive challenges (cognitive stimulations) may be provided, including, for example:

A) cognitive task(s) that are not related to the physical balance tasks. Such tasks may include, for example, find the differences between two pictures, find the odd one out, recognize famous places in the world, colored Stroop test and the like, or any combination thereof. This type of tasks may be provided for beginner subject or for those whose balance skills are low. In these task the correct and incorrect answers as well as time to answer may be determined and stored/recorded. When the user succeeds in X % (such as, for example, 80%) of the tasks and his/her average time to answer is lower than Y seconds (for example, about 10-20 seconds), the next difficulty level may be suggested or implemented for the next training session. In some embodiments, the next level may include cognitive task(s) that are not related to the physical balance tasks but reaction time for responding is measured and recorded. Such exemplary tasks include, for example, tasks find the next number in invoice series, find a synonym phrase for a presented word and the like. These tasks can also be provided for beginner subject that has moderate balance skills. When the user succeeds in X % (such as, for example, 80%) of the tasks and his/her average time to answer is lower than Y seconds (for example, about 3-10 seconds), the next difficulty level may be suggested or implemented for the next training session.

B) balance gaming—another type of cognitive tasks includes tasks that are related to the physical balance tasks. Such tasks may be in the form of games, that may depend on the siting position during the balance training and designed for users with moderate balance skills and above. The balance games train, in various level, fast balance responses, memory capability, information processing, motor planning, and the like, or any combination thereof. Each possibility is a separate embodiment. In some embodiments, real time feedback may be provided for balance performance. In some embodiments, the games include such games as avoiding obstacles or obstacles popping up along the way while cycling or kayaking. In some embodiments, while in standing position the games may include avoiding (by trunk and arms balance movements) logs in the river while hands-free kayaking or maneuver when cycling between people running in a park or stay standing on a surfboard when waves crash on the user. In such instances, the mechanical balance perturbations may be provided simultaneously and respectively to the cognitive balance games presented on the user screen. According to some embodiments, another game option is to connect to street view or pre-scanned environment, such that the subject can, e.g., go walking in a virtual environment during perturbation training. In some embodiment, virtual reality (VR) glasses may be worn by the user.

According to some embodiments, feedback to the subject's responses and performance while perturbation training may be provided in various means, including, for example, audible feedback, visual feedback and/or tactile feedback, preferably in real time. According to some embodiments, the feedback may be voice-based feedback. Such feedback may include voice communication between the system and the subject such that the system is configured to recognize the subject's voice and provide vocal feedback. For example: the user was able to answer a cognitive task presented aloud, the system recognizes his voice and marks the answer given, and also gives voice feedback on whether the answer is correct. According to some embodiments, the feedback may be tactile. In such a setting, the subject may hold a wireless button and can respond with the push of a button in response to a cognitive task displayed on the screen/display. Cognitive reaction time and the number of correct answers may be measured, and, based thereon, a cognitive score may be provided at the end of the training session. In some embodiments, the feedback may be provided in real time, by visual feedback presented on the screen, for example, in the form of a mark or a score. In some embodiments, the feedback may be provided utilizing eye-tracker glasses configured to identity the screen location on which the subject is looking in response to a cognitive task displayed on the screen/display. Based on the location, the cognitive reaction time and the number of correct answers may be determined.

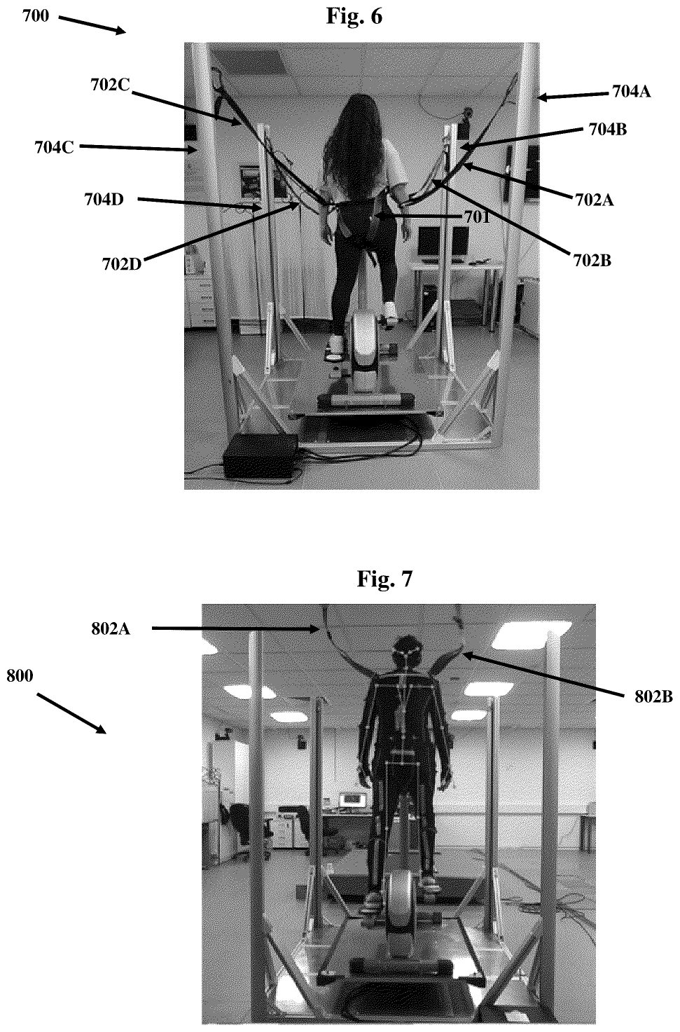

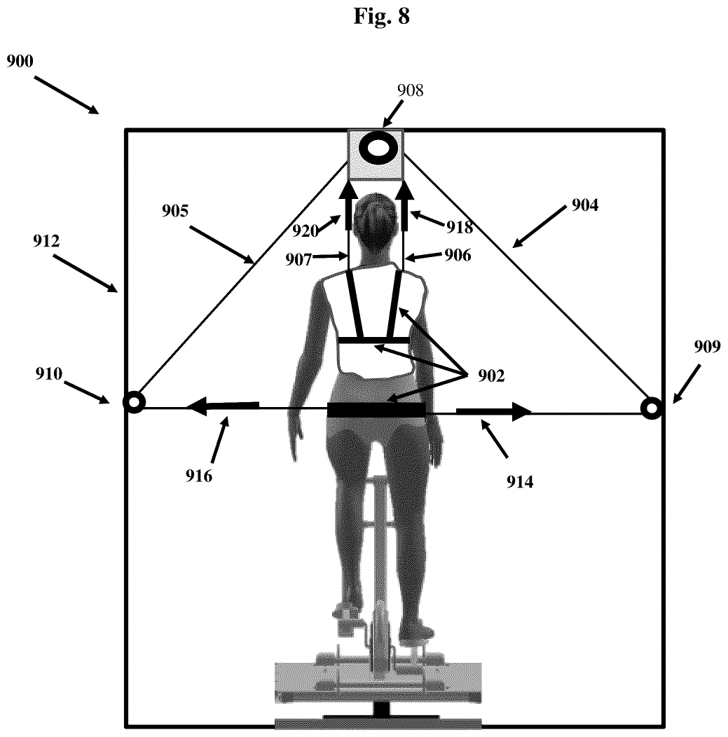

According to some embodiments, safety is an important issue since unexpected perturbations are applied to the subject and may cause falling of the system. The subjects are instructed to recover from the perturbations using upper body movements as fast as they possibly can, which is the most important part of the training regimen. The motion tracking unit tracks their recovery balance movement responses (for example, side bending of the trunk) to result in platform and stepper movement back to the starting position. In a study conducted by the inventors, it was found that young individuals respond by trunk response to the opposite direction of the perturbation to quickly move the upper body COM toward the base of support. In case the subject fails to recover and falls, the system comprises a safety harness that can arrest the fall. The harness is slightly loose to be safe, but does not restrict reactive and proactive balance response. Examples of such a safety harness are the Skylotec G-0904 or the PN12 harness. The safety harness may be hung from an arm or pole/bar of the system (for example, shown in FIG. 6), or may be hung from the ceiling (for example, FIG. 7). For stability reasons the ropes do not necessarily hang straight from the ceiling or arm, but in a diagonal such that the distance between the connection points of the two ropes on the ceiling or arm is about 2 m. When the rope is hanged in diagonal it is capable of applying much larger horizontal force in order to keep and stabilize the patient at the center.

Reference is now made to FIG. 6, which shows a safety harness, in some embodiments. As shown in FIG. 6, exemplary system (700) includes a safety element such as a safety harness (701), which is configured to secure the subject and prevent or hold the subject, so he does not accidently fall during a training session. The exemplified safety elements comprise four straps (or ropes) (702A-D), which are each attached at one end to the subject, and at the other end to a respective pole (704A-D). In some embodiments, the straps are attached to the subject by being attached to a waist belt/harness. In some embodiments, the straps are attached to the subject by being attached to a body belt/harness.

Reference is now made to FIG. 7, which shows a safety harness, in some other embodiments. As shown in FIG. 7, exemplary system (800) includes a safety element such as a safety harness, which is configured to secure the subject and prevent or hold the subject, so he does not accidently fall during a training session. The exemplified safety elements comprise two straps (or ropes) (802A-B), which are which are each attached at one end to the subject, and at the other end to the ceiling.

It is appreciated that the embodiments shown in FIGS. 6 and 7 are merely examples, and straps or ropes may be attached to any other element that can provide the safety feature as explained above, such as, for example, an overhead rail, or a rail in any appropriate position. The harness is adjusted so that, with full body weight support by the harness, the subject's knees could come close to, but not touch, the platform. In some embodiments, the harness is configured to objectively evaluate/measure harness support which may also provide information for the trainer for cases in which harness support is stretched. In some embodiments, a cutoff level of harness support (for example, about 20% body weight) which is indicative that the subject failed to respond appropriately to the provided balance stimulation.

In addition to providing safety from falling, the harness may also provide pull perturbations, to further help with balance training. The pull perturbations may be directly to the sides, from the top (e.g., at one shoulder), or in a diagonal direction.

In some embodiments, the harness is hung from the ceiling. In some embodiments, the harness is hung from poles/bars or another appropriate support that may or may not be connected to the system.

In some embodiments, the safety harness is suspended by at least one rope that is attached to at least one point above the subject. In some embodiments, the at least one rope is connected to the ceiling. In some embodiments, the at least one rope is connected to elements of the system, such as bars or poles. In some embodiments the at least one rope is one rope. In some embodiments the at least one rope is two ropes. In some embodiments the at least one rope is three ropes. In some embodiments the at least one rope is four ropes. In some embodiments the at least one rope is more than four ropes.

In some embodiments, the safety harness is suspended by 4 ropes placed in four corners around the subject.

In some embodiments, the system is stationary, and the harness is suspended from the ceiling by two ropes above the subject. The harness used in this case is usually a body harness.

In some embodiments, the system is mobile, and two adjustable straps (or ropes) are attached to the harness on each side of the subject (right and left), each of which being fixed to one of the four side rods of the system. The harness used in this case is usually a waist harness.

In addition to safety, the harness may be further used to provide pull perturbations on the subject.

Reference is now made to FIG. 8, which shows a harness, in some other embodiments. As shown in FIG. 8, exemplary system (900) comprises a harness (902), which is connected to a series of ropes (904), (905), (906), and (907). Ropes (904) and (905) are connected to motor (908) by respective pulleys (909) and (910), and ropes (906) and (907) are directly connected to motor (908). Pulleys (909) and (910) and motor (908) may be anchored to a frame (912) or may be connected to poles or bars, walls or ceiling. The ropes, via the system of the motor and/or pullies, may be pulled by the motor, thereby exerting pull forces on the subject by pulling on the harness. For example, arrow (914) shows a right pull force exerted by rope (904) being pulled through pulley (909), while arrow (916) shows a left pull force exerted by rope (905) being pulled through pulley (910). Arrows (918) and (920) show upward pull of respective ropes (906) and (907) by motor 908.

It is appreciated that FIG. 8 only presents one embodiment of the harness system and other configurations are possible, such as different types and arrangements of ropes and pulleys, more than a single motor responsible for the different forces or directions, etc. A single pull force may be exerted at one time, or a combination of forces in different directions maybe exerted together at the same time. The pull perturbations may be expected or unexpected, similar to other perturbations in this application. The pull perturbations may be used alone, or in combination with any other perturbation mentioned herein. In some embodiments, the motor used for the pull perturbation is similar to other motors of the present invention. In some embodiments, the motor used for the pull perturbation is different from other motors of the present invention.

A further use for the harness of the invention is for training astronauts in weightless environments, such as in a space station, to prevent muscle waste due to the lack of gravitational force. The training system may be used in a weightless environment, while the subject is being pulled down by a force equal (or similar) to the subject's weight, which simulates practice on earth.

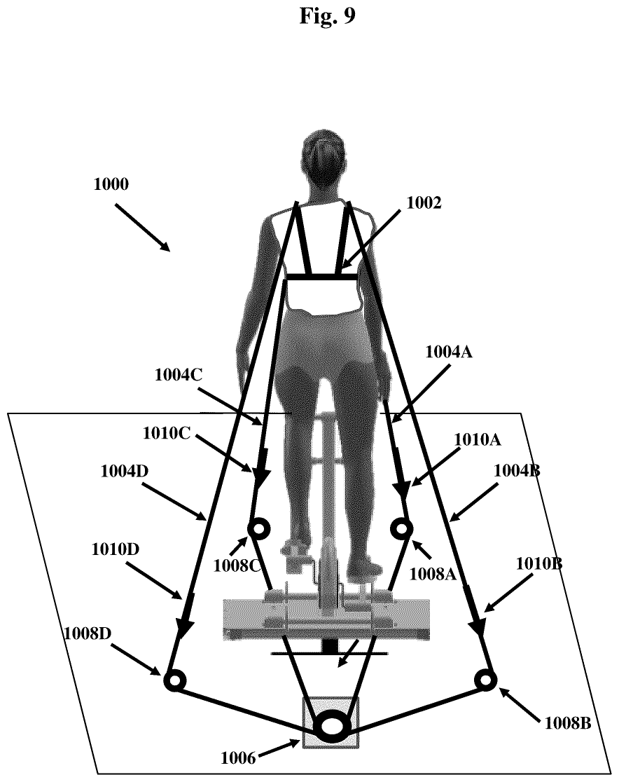

Reference is now made to FIG. 9, which shows a harness, in some other embodiments. As shown in FIG. 9, exemplary system (1000) comprises ropes or straps (1004A-D) which are attached to harness (1002) at one end, and to a motor (1006) via a series of pulleys (1008A-D, respectively) at the other end. The ropes or straps (1004A-D) exert respective downward pull forces (1010A-D) on the subject, at a magnitude similar to the weight of the subject. This system is intended for use in a weightless environment, such as in a space station.

It is understood that FIG. 9 is merely an embodiment, and the number and arrangement of ropes, pulleys, and motor(s) may vary to achieve the same goal of a downward pull on the subject.

In some embodiments, the harness is a body harness. In some embodiments, the harness is a waist harness.

In some embodiment, the system is stationary. In some embodiments, the system is mobile.

The term “stationary”, as used herein with reference to the system, means that the system cannot be easily moved from one place to another, and is generally intended to be used in one place. The term “mobile”, as used herein with reference to the system, means that the system can be relatively easily disassembled and moved to different places. For a mobile system, the harness may be anchored to bars/posed that are attached to the system.

It is appreciated that while the embodiments presented above all disclose a movable platform, it is also conceivable that the system does not include a movable platform but instead includes stepper motors, and all perturbations are induced by the stepper motors.

For example, in some such embodiments, the system comprises a supported in-place walking trainer (SUIT) such as an elliptical trainer comprising a first stepper operably connected to a first stepper motor, and a second stepper operably connected to a second stepper motor, the first and the second stepper motors being configured to control movement of the first and the second stepper, respectively, and a central control unit.

In these embodiments, each stepper may be connected to the SUIT by an axis and provide perturbations to the subject in a similar way to that described herein for the movable platform.

In some embodiments, the system can be self-operated by a subject, for example, in home use. Thus, the subject by himself/herself operates the system and can train on the system on his own.

According to some embodiments, the system and methods disclosed herein allow implicit learning of the subject to improve balance.

According to some embodiments, the system may include a programming mode (editing mode) and a working mode. Switching between modes may be achieved by a safety pin micro-switch which may be pressed by the subject. The modes are determined by the motion control system that checks whether the safety pin micro-switch is pressed or not and sends this data to the main computer program. When the safety pin is closed (pressed micro-switch), the motors do not receive electric current, and the user can edit or create a new training program or to choose the automatic computer program (AI-based program) by the user interface (on the host PC), but cannot start running it. When the safety pin is open (unpressed micro-switch), the servo motor receives electric current, and the user may start the training program, but cannot change data on it. Thus, for running a training program, the user first creates a customized training program with the program user interface and saves it on the computer (programming mode) or chooses the automatic AI-based program for the current training session. Second, in working mode, the computer program runs/executes the training program by utilizing the motor's motion control system and the motion capture cameras unit. The computer program communicates with the motor's motion control system and with the motion capture cameras that monitor the subject's movements all along a training session. The motion control unit analyzes the data received from the computer program and the motors to determine the next movement the motor makes, according to the training program (whether it was manually programmed or automatically programmed based on the AI computer program). For executing a perturbation command, according to the training program, the motor's motion control system conducts electric current to the motors, which are connected to the movable platform/stepper by suitable gear ratios to increase the applied moment on the platform/stepper. The movable platform/stepper is perturbed according to the executed programmed perturbation. During the executed perturbation, once the motion capture cameras detect an appropriate effective upper-body balance reaction (based on the AI balance training executable instructions), the perturbation is immediately stopped, and the motor returns the movable platform/stepper to a vertical zero position by motor counter-rotation. In some embodiments, the subject's heart rate and gripping the grip handles may be monitored by sensors located on the grip handles. Some or all of the related data may be presented on the user screen throughout the program training session. After the training program, the user may review any of the related data, including, for example, video footage, moving graphs, and any of the additional data collected during a selected training session. In some embodiments, some or all of the data may be used by the computer program to determine next training sessions. In some embodiments, after the training session, the trainer may review the video footage, the subject's moving graphs and/or the data collected in order to determine the next training session.

A training program (or training plan) may include parameters such as: number of training sessions in a complete training program, length of a training session, number of perturbations (repetitions) per training session, intervals between perturbations, whether perturbations are block (expected) or random (unexpected) perturbations, parameters of each perturbation (such as tilt angle, max acceleration/deceleration, max angular velocity, perturbation profile, etc.), extrinsic vs. intrinsic perturbations, a warning prior to expected perturbations, etc. Further, the training program may also include parameters related to the speed of walking (resistance to walking). Any of these parameters may be controlled by the system or by the subject.

Feedback to the subject's responses received by the system may include, e.g., elevating the difficulty level by increasing resistance to the walking, or elevating the intensity of perturbations (higher tilt angels, acceleration/deceleration, etc.).

A session length may be around 15-25 minutes, or about 20 minutes. Each session may include about 3-minute self-paced warm-up walking (during which time the system is calibrated), and about 17 minutes of perturbation training. The number of sessions may be around 10-20 sessions per program.

According to some embodiments, the motion control system is based on the motion controller and is communicated via an interface, such as, Modbus through the computer program. The computer program utilizes the motion control unit to communicate with the motors, which in turn execute the perturbations of the movable platform or steppers. From the computer program, the motion controller may receive the required information of the direction, the tilt angle, maximum angular velocity, and maximum acceleration/deceleration. The motion controller includes an internal motion profile generator that generates a trapezoidal velocity profile. Since acceleration is of great importance in providing unexpected perturbations as well as real-time implicit feedback for balance reactions, a triangular velocity profile for perturbation rotation and feedback counter rotation are utilized. The movable platform/stepper accelerates for generating the required external perturbations and then decelerates to zero velocity, when a balance response is detected or not.

According to some embodiments, a motion capture unit/system (such as, a ZED 2™ from Stercolabs or a Microsoft Kinect™ sensors, Intel RealSense™ cameras or similar video motion capturing device) is associated with or integrated with the system. The motion capture unit is configured to capture in real time the body posture i.e., stick figure, and is included with the system for two main reasons. First, the motion capture unit allows to identify whether the subject attempts to perform a reactive/compensatory balance reaction trying to straighten the system to its 0° neutral position following an external perturbation. Second, the motion capture unit allows to capture throughout the trial the upper skeleton posture i.e., stick figure, including the shoulders, arms, head, and hands. Then, collect information about the subject's balance movements with respect to the current system state, and to analyze the subject's responses to ongoing events. In some embodiments, it was found that the correlations between Stercolabs ZED 2™ and 3D motion analysis is high for the reactive/compensatory leg movements (r=0.75-0.78, p=0.04). Thus, using a motion capture unit, such as a ZED 2™ or a Microsoft Kinect™ system provides comparable data to a video-based 3D motion analysis system when assessing reactive balance responses in the clinic.

In some exemplary embodiments, the system comprises a central control unit, such as a PC, which is programmable, e.g., by python programming language. The central control unit provides input to a graphical interface (a display for the user) and to the motion capture unit (e.g., a camera, as detailed herein). The motion capture unit receives input from the subject by tracking their movement, and provides output to the central control unit, regarding position of the subject. The central control unit uses the input received from the motion capture unit and provides instructions to an API which is connected to controllers which control the motors of the system, such as the platform and the stepper motors. The controllers then cause movement of the system motors according to instructions received from the central control unit.

In some embodiments, only some of the body joints that the motion capture unit interface provides, may be used. In some embodiments, the system calculates and saves parameters including: detected angles of the subject's body (including right hand, left hand, forward-back back angle, left-right back angle, shoulder angle) in various situations, such as tilt angles of the motion platform, including roll and pitch.

In some embodiments, the motion information concerning such joints was occasional, less accurate, and very noisy. Several angles (joint angles α1-α5 and system angles α6-α7) were calculated, that were considered in the computer program: α1) Shoulders angle: The angle between the line between the two shoulders of the subject and the ground.; α2) L-R back angle: The angle of the line from the trainee's center of mass (COM) to the trainee's chest relative to the line vertical to the ground on the left-right axis; α3) F-B back angle: The angle of the line from the CoM to the chest relative to the line vertical to the ground on the back-front axis; α4) Left elbow angle: The angle between the line from the left elbow to the left shoulder joints of the trainee and the line vertical to the ground on the left-right axis; α5) Right elbow angle: The angle between the line from the right elbow to the right shoulder joints of the trainee and the line vertical to the ground on the left-right axis; α6) System roll angle: The angle of the motion platform on the left-right axis. A7) System pitch angle: The angle of the motion platform on the front-back axis. One or more, or any combination of said angles may be used in the calculations.

In some embodiments, angles α1 and α2 may be used in the real-time training process for identifying the subject's body position with respect to the SUIT, in order to compute the moment an effective balance response was shown and to tilting back the SUIT. In some embodiments, Angels α4-α5 are not necessarily used during real-time training process but are shown in post-training graphs for advanced post-training analysis. In some embodiments, all body part locations are logged in each frame that was taken by the ZED 2™ system for post-training calculations of these angles.

According to some embodiments, the training system includes a user interface. In some embodiments, the computer program that serves as the system's user interface can run/be executed on a host PC. In some exemplary embodiments, the user interface application may be of a Windows format and may include three tabs: choosing and running a training program, creating a new training program, and a pop-up exiting window for saving the data captured and the post-training data and video clips tab. In some embodiments, the run training-program tab is the main tab which allows the user to choose the subject's training program, whether it was manually programmed, or an automatic option was selected, and starts running/executing the exercise sequence in which a series of perturbations is applied to the user/subject. The tab allows creating or loading the subject's details (such as, name), opening training history is opened, selecting and loading training program (for example, from a menu). In some embodiments, the create new training program button allows opening the setting parameter tab, starting/pausing the training, selecting motion capture unit, selecting whether to utilize motion feedback, controlling an emergency stop button (configured to lock the motor immediately and stops the movable platform), controlling a release brake button (which is configured to release the latch from the motor so the movable platform can freely move to all optional directions. Further optional tabs may include a screen showing the real-time frames as recorded by the motion capture cameras of the motion capture unit, marking the camera's circle locations on the subject's body joints that the system identifies; a screen showing the perturbation details of the chosen training program, a list of previous and remining perturbations and marks the coming perturbation; a timer for the total time spent in the current training program; the platform/stepper angle, the real-time movable platform angle received from the motors; body angle, the real-time subject's shoulder angle that is received from the motion capture cameras system; body angle at last perturbation, the shoulder angle at the point at which the user has made the desired balance movements to trigger the system to automatically stop the perturbation; and connectivity checks for the motion capture cameras system, for the motor and movable platform/stepper and for the overall system.

According to some embodiments, the creating training program tab enables creation of a new customized training program. In some embodiments, the programming of a new training program may be manual and may allow manual programming, including, for example, control of all parameters of the perturbations (magnitude, angular velocity, acceleration, frequency), control of the motor mode (stable or “floating” between the external perturbations), determination of block or random perturbation training, and the like. In the setting process, each perturbation may be programmed separately and added in chronological order to the list of perturbations composing the customized training program. For each perturbation, the user may set the maximal desired values of the motion profile parameters, as long as a balance response is not detected by the motion capture cameras system (acceleration, deceleration, angular velocity, and perturbation angle). When a balance reaction is detected, the motor does not complete its predetermined operation and, therefore, does not necessarily execute the motion profile according to the programmed maximal values. The delay time between each two consecutive perturbations, the tilting direction, and the number of perturbations during a single experiment or training may also be selected. In addition, the balance response threshold parameter may also be selected. This parameter determines at what degree of balance response the subject receives biofeedback in form of immediately returning the movable platform to its neutral position. This parameter is customized for each subject based on the automatic calibration phase and by studying the same subject's balance response behavior based on past trainings. The result of this unique parameter is the customized training program. Accordingly, the balance response threshold parameter is the only set parameter the user/trainer can calibrate in real time while executing a training program for obtaining better biofeedback and a better motor learning process. In some embodiments, the programming of a new training program may be automatic programming. In some setting, the computer software, based on the AI previously obtained data (training), adjusts the next training session for the subject according to the performance of the last training sessions, the frequency and duration of the last trainings while considering the date of the last training and the balance performance that are combined with the calibration data of the previous and current training session. The adjustment of the training may be made by adjusting the duration of training, frequency of perturbations per minute, magnitudes and speed of perturbations, and the like, or any combination thereof.

According to some embodiments, additional user interface tabs may include, for example, saving data tab which allows the user to save or discard the training session data and video frames taken by the motion capture cameras unit. In some embodiments, a performance history tab may display training data, including, for example, how many perturbations the subject has passed the reactive balance response threshold, graphs of the entire training and upper body responses (i.e., shoulder line movement, trunk movement and arms movements). This tab enables the trainer/user to analyze the kinematic data of a specific balance reaction in a specific training session. In some embodiments, two different kinematic graphs of the calculated angles related to the movable platform/stepper position in each frame taken by the motion capture cameras unit may be presented. Optionally, also presented are other diagrams, including, for example each frame of the subject's skeleton image (body stick figure) and of the platform or stepper positions that were acquired by the motion capture cameras unit during the training session. In addition, a moveable timeline may be presented, thereby allowing the trainer to observe the angles and the body stick figure at every timestamp, compared to the platform/stepper angle position at that timestamp. In some embodiments, the computer program further allows watching the training session as a movie, optionally while pausing at specific frames.

According to some embodiments, the central control unit of the system includes one or more processors (for example, in the form of host PC) that are configured to execute a computer program (executable instructions) which is configured to control operation of the training system and, inter alia, provide real time feedback to the subject regarding reactive balance reactions and/or success in cognitive tasks and/or to determine the next training session. In some embodiments, at least some of the computer program include machine learning and Artificial intelligence (AI) algorithms, which can: provide the subject real time feedback to reactive balance reactions and/or to success in the cognitive tasks and/or B) builds the next balance training.

The Al algorithm utilized includes online processing and/or offline processing. According to some embodiments, the online processing may be executed by a local processing unit. In some embodiments, the online processing is configured to provide the subject with real time feedback to reactive balance reactions during balance exercise. Firstly, calibration stage is performed (for example, in the length of 60-180 seconds, such as, for example, 90 seconds). At the end of the calibration stage, the Al computer program and the motion capture cameras unit can automatically customize the system to the current subject by calculating: 1) the individual upper body sway amplitude during walking without perturbations, and/or 2) the Subject-zero point. Next, during the customization process, certain angles are recorded separately for a period of time (for example, 60-180 seconds, such as, 90 seconds), during the second part of the calibration stage, that can last for example, for a total of 2-5 minutes (such as, 3 minutes). At the end of this stage, the individual upper body sway amplitude and the platform/stepper zero point are calculated for the relevant angles). Thereafter, the angles that show more stability and less noisy parameters are automatically selected to be the angle on which the Al algorithm (software) relies on, in order to set the balance threshold parameter and to provide the real-time sensorimotor feedback for an effective balance reaction, by returning the platform/stepper to their original position. Thereafter, during balance exercise stage, the subject is exposed to a variety of repeated random unexpected perturbations, as detailed above herein. When each of the perturbation is executed, the Al computer program analyzes (checks) the difference between the body angles and the platform/stepper angle and takes into account the body amplitude of the user and the platform/stepper zero point to determine if a significant balance reactive recovery response rather than a regular walking movement was detected. In case the system detected an effective reactive balance reaction (higher than the balance threshold parameter), that was identified by the motion capture cameras system, the platform/stepper tilt rotation (i.e., the perturbation) is stopped immediately, and the motor returns the platform/stepper to its original position (i.e., its neutral/zero position) by motor counter-rotation. At the end of the current training session, a summary of the current exercise session may be provided to user. The summary may include various parameters, including, for example, number and percentage of effective balance responses, number and percentage of time the subject held the handlebar for assistance, success in cognitive tasks and/or walking data (such as, time, distance and set resistance). At the end of the current training session, the next training session may be presented. In some embodiments, a training program (for example, bi-weekly program) may also be presented.

According to some embodiments, the offline processing may be performed on a database server (local or remote server). In some embodiments, after each training session the AI program is configured to collect all or at least part of the data from the motor's motion control system, motion capture unit, steppers, grip handles (heart rate monitor and/or pressure sensors), cognitive tasks, and the like or any combination thereof. Based on the collected data the AI program can analyze one or more of:
1. Last training sessions parameters: number and percentage of effective balance responses, wherein only if the percentage of effective responses is over a predetermined threshold (for example, over 80% effective responses), the AI algorithm may offers the next level of perturbation training (otherwise the same level of training is offered); number and percentage of time that the subject held the handlebar, wherein only if the percentage of time of hands free walking is determined (for example, over 80% of the time with hands-free walking) the AI program may offer the next level of perturbation training (otherwise the same level of training is offered); number and percentage of successful cognitive tasks answer and games wherein only if the percentage of correct answers and/or correct movements during execution of the cognitive tasks are correct (for example over 80% correct answers and correct movements during cognitive balance tasks), the AI algorithm may offer the next level of cognitive tasks (otherwise the same level of training is offered); walking data (including, time, distance, resistance); training frequency; training min./last month and/or last week; positions in the last training session; and the like, or any combination thereof;
2. Summary of the last exercise session and when it was executed;
3. Summary of the last assessment session.

Based on at least part of such data, the AI algorithm is configured to 1) build and present the next balance training session (position, perturbation type, all perturbation parameters-magnitudes, velocities, accelerations, frequencies and type of perturbations, level of cognitive tasks); 2) Build and present a bi-weekly training program and progression (position, perturbation type, all perturbation parameters-magnitudes, velocities, accelerations, frequencies and type of perturbations, next cognitive tasks, walking resistance) and/or 3) Build and notify the next assessment session (when/what/how to examine the subject (by himself and/or by a trainer).

According to some embodiments, the data collected and/or analyzed by the system may be used for training the machine learning models. In some embodiments, data collected from various training systems may be used in the training processing. In some embodiments, the data collected from a plurality of training systems (each may be located in a remote location) may be stored and/or at least processed on a remote server (such as, a cloud-based server, or any type of server).

In some embodiments the training system further includes a communication unit. In some embodiments, the remote server may be functionally associated with the control unit of the system via the communication unit.

In some embodiments, there is provided a method for training or improving balance control of a subject, the method comprising:
providing one or more unexpected external perturbations to a subject using the system described herein;
detecting a reactive balance response of the subject to the external perturbations based on data acquired by the motion capture unit of the system;
analyzing the detected reactive and proactive balance response of the subject; and
providing feedback to the subject if the balance response is determined to be above a balance response threshold.

In some embodiments, the method further comprises providing a cognitive challenge to the subject and determining a cognitive performance of the subject, based on the response to the cognitive challenge.

In some embodiments, the cognitive challenge is provided in synchronization with an unexpected external perturbation.

In some embodiments, the balance response threshold is customized to the subject. In some embodiments, the balance response threshold is determined based on calibration and/or previous training sessions.

In some embodiments, the feedback comprises stopping the perturbation and returning the platform to a neutral position.

In some embodiments, the analysis of the detected balance response and/or cognitive performance is performed by a computer program comprising AI algorithms. In some embodiments, the computer program is configured to provide feedback to the subject indicative of the performance of the subject in the reactive balance response and/or the cognitive challenge.

In some embodiments, the computer program is further configured to adjust operating parameters of the training session based at least in part on the analyzed reactive balance response.

In some embodiments, the operating parameters comprise: type of perturbation, maximum acceleration/deceleration of a perturbation, maximum angular velocity of a perturbation, magnitude of a perturbation, angle of perturbation, number of perturbation repetitions, the delay time between the perturbations, or any combination thereof.

In some embodiments, the computer program is further configured to determine or recommend operating parameters of a following training session and/or a training plan said training plan comprises two or more training sessions.

In some embodiments, there is provided a computer-readable storage medium having stored therein machine learning software, executable by one or more processors for executing the method disclosed herein.

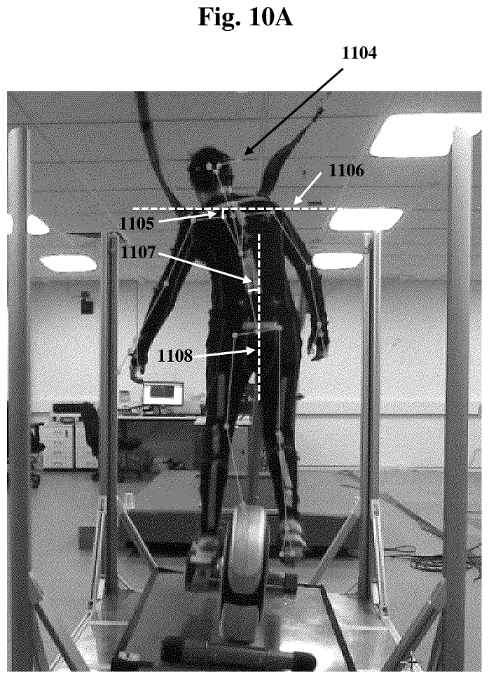

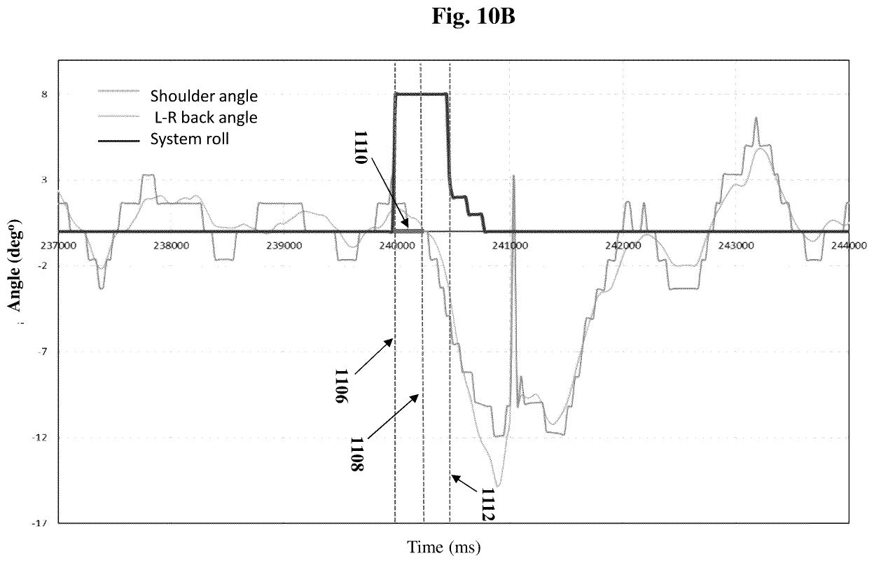

Reference is made to FIGS. 10A-10B, FIGS. 11A-11B and FIGS. 12A-12B, which show examples for the implementation of the motion capture unit-system and method function during training process. These figures present short samples of the motion capture unit during a training process. In this example, two young adults were exposed to unannounced right-left and anterior-posterior balance perturbations while in-place walking on the system (with an elliptical trainer). The tilting perturbations evoked balance reactive trunk, head, and arm movements always in the opposite direction of the perturbation to quickly move the upper body's center of mass (COM) toward the base of support provided by the steppers. Both subjects performed upper body balance reactive responses during the training session. Additional details are described in the Experimental section below.

Each training session consists of two phases: calibration and perturbation. First, by calibrating, the effective balance response threshold during in-place walking on the elliptical is identified and personalized for each trainee. Secondly, during the perturbation phase, when the trainee responds well to perturbations, the system provides a customized intrinsic sensorimotor cue. This is done by stopping the perturbation immediately and returning the system to its horizontal position. Angles α1 (shoulders) and α2 (left-right back) were used in the real-time training process to detect the trainee's body position with respect to the calibration angles to check whether an effective balance reactive response was performed when the system performs roll (left-right) perturbation. Angle α3 (F-B back) was used for the same purpose when the system performs pitch (forward-backward) perturbation. Angles α4-α7 (left and right elbow, system roll and pitch) were not used during the real-time training process but are shown in post-training graphs for advanced post-training analysis. Monitoring the trainee's balance responses according to the system movement over time can indicate the implementation of skill acquisition and the motor learning progress of the balance upper-body reactive responses. The data of angles α1-α5 (subject's position) reveals all the information about the balance reactions. For example, the arm reactions (α4 and α5), which are part of the training goal, are reflected in all types of perturbations, but the other angles measured represent more reliable information about the nature of the response according to the perturbation. Therefore, the calculation is not based on the α4 and α5 angles. However, they can be helpful in clarifying the entire response to perturbations.

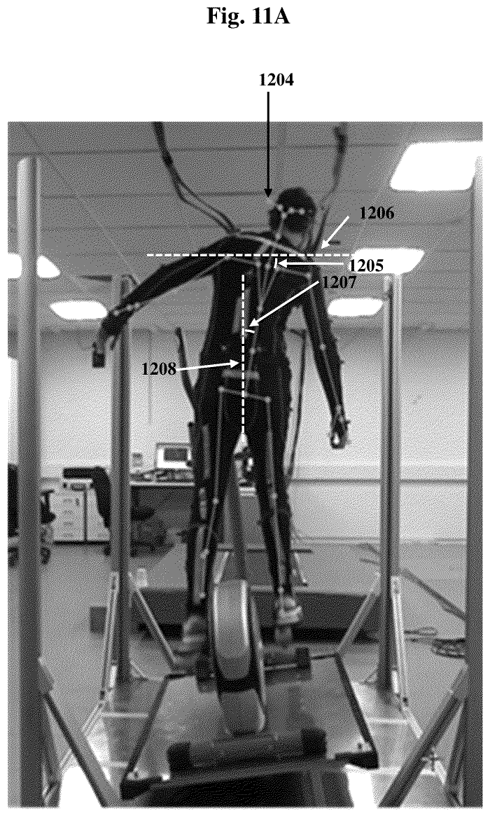

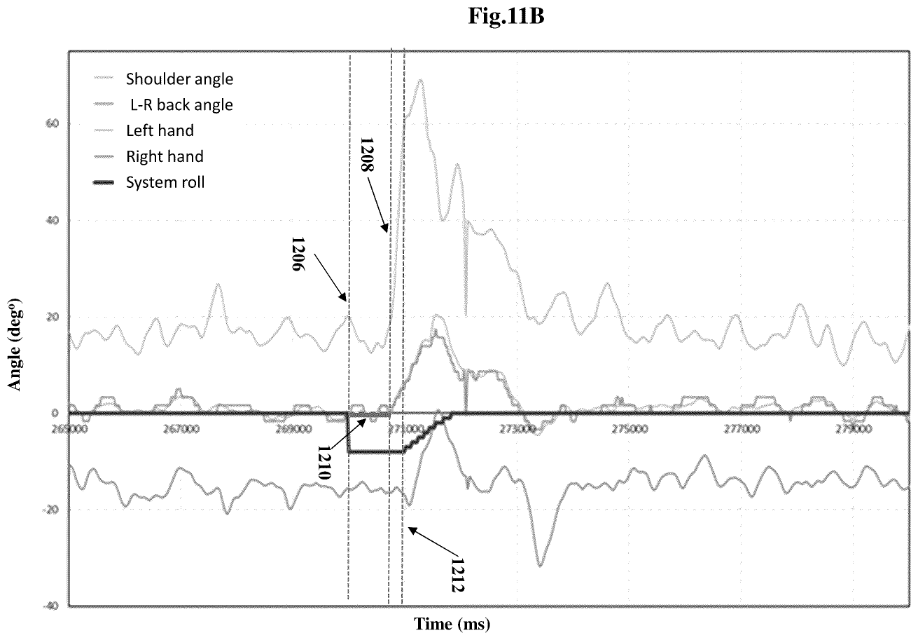

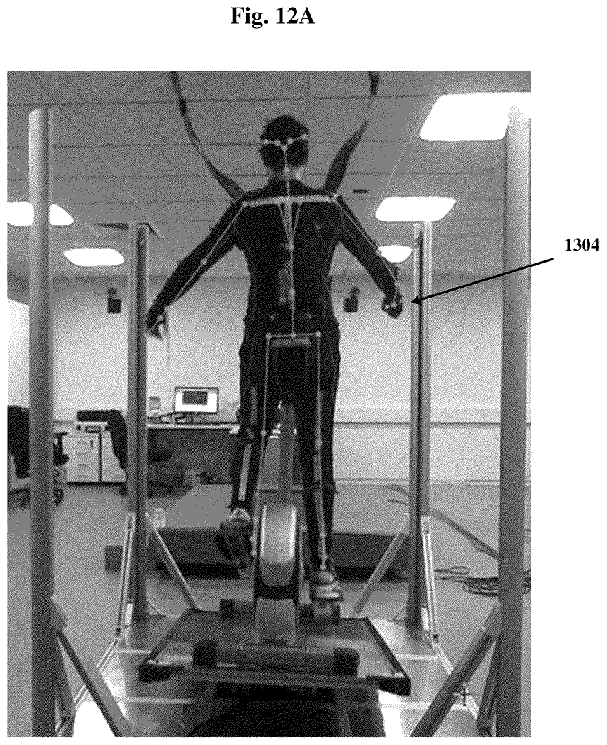

The trunk, shoulder and arms reactive responses during the training sessions are demonstrated in FIGS. 10A-10B and 11A-11B. Upper body balance reactive responses are presented by the shoulder line and trunk/back and arms angles. These angles were found to be the best parameters to distinguish the presence of an upper body balance reactive response.

Reference is now made to FIGS. 10A and 10B, which show the implementation of the motion capture unit-system function during training process with an 8° right tilt perturbation. In the example, the subject walked with, and then without, holding the elliptical system handlebars (i.e., hands-free). The subject was then exposed to 8° right unannounced perturbations during hands-free in-place walking. FIG. 10A shows a pictogram of a subject during training. Stick FIG. 1104 shows the positions of various joint angles. Angle 1105 is the shoulder angle (dashed line 1106 is parallel to the ground), and angle 1107 is the left back angle (dashed line 1108 is vertical to the ground). The software was able to accurately identify shoulder and trunk/back balance reactive responses. FIG. 10B shows a graphical representation of the positions of the system and of the subject during the 8° right tilt perturbation. The systems roll angle increase abruptly (dark blue line), which was followed by a large balance recovery reaction as seen by the left trunk (L-R back angle-orange line) and shoulder angle (light blue line), as detected by the 3D camera. Arrow 1106 shows the time of the system roll perturbation; arrow 1108 shows the time of the subject's response; arrow 1110 shows the balance recovery reaction time; and arrow 1112 shows the time of the system returning to its initial horizontal condition, due to software detection and identification of a good balance recovery response.

Reference is now made to FIGS. 11A and 11B, which show the implementation of the motion capture unit-system function during training process with an 8° left tilt perturbation. In this example, the subject walked with, and then without, holding the elliptical system handlebars (i.e., hands-free). Then the subject was exposed to 8° left unannounced perturbations during hands-free in-place walking. FIG. 11A shows a pictogram of a subject during training. Stick FIG. 1204 shows the positions of various joint angles. Angle 1205 is the shoulder angle (dashed line 1206 is parallel to the ground), and angle 1207 is the right back angle (dashed line 1208 is vertical to the ground). The software was able to accurately identify shoulder and trunk/back balance reactive responses. FIG. 11B shows a graphical representation of the positions of the system and of the subject during the 8° left tilt perturbation. A large balance recovery reaction is seen by the left arm angle (left hand—yellow line), trunk (back—orange line) and shoulder angle (light blue line) as detected by the 3D camera. This reaction was triggered by the unexpected tilt perturbation to the left, i.e., the systems roll angle increased dramatically (dark blue line). Arrow 1206 shows the time of the system left perturbation; arrow 1208 shows the time of the arms, trunk and shoulder response; arrow 1210 shows the balance recovery reaction time; and arrow 1212 shows the time of system returning to its initial horizontal condition, following software detection and identification of a good balance recovery response by the subject.

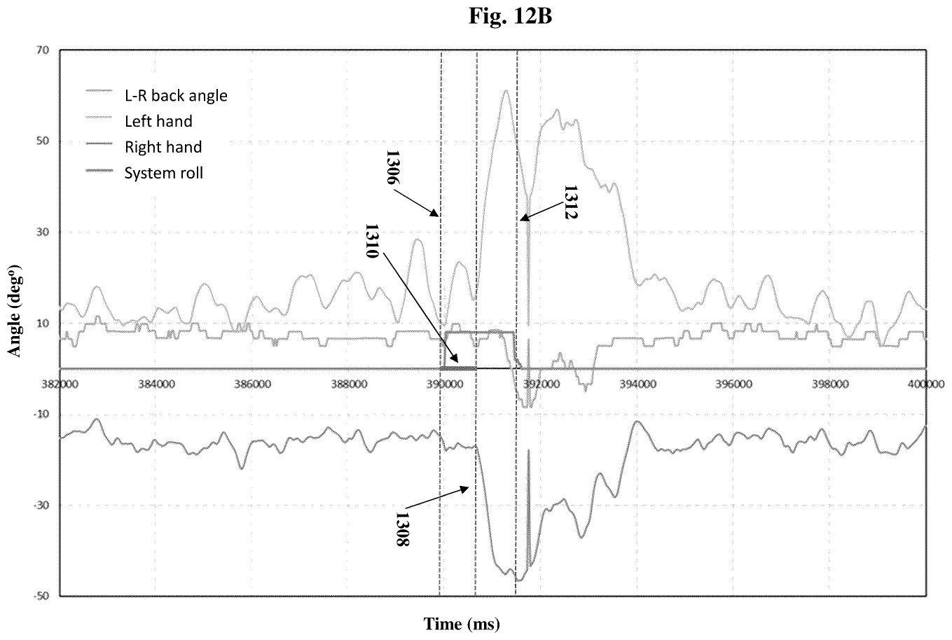

Reference is now made to FIGS. 12A and 12B, which shows the implementation of the motion capture unit-system function during training process with an 8° backward perturbation. In this example, the subject walked with, and then without, holding the elliptical system handlebars (i.e., hands-free). Then the subject was exposed to 8° backward unannounced perturbations during hands-free in-place walking. FIG. 12A shows a pictogram of a subject during training. Stick FIG. 1304 shows the positions of various joint angles. The software was able to accurately identify shoulder and trunk/back balance reactive responses. FIG. 12B shows a graphical representation of the positions of the system and of the subject during the 8° backwards tilt perturbation. A large balance recovery reaction forward is seen by both arm angles (left hand-yellow), right arm (light blue) and trunk/upper back angle (purple line) as detected by the 3D camera which is triggered by the unexpected a tilt backward perturbation, i.e., the systems pitch angle increased dramatically (Green line). Arrow 1306 shows the time of the system pitch perturbation; arrow 1308 shows the time of the subject's response; arrow 1310 shows the balance recovery reaction time; and arrow 1312 shows the time of the system returning to its initial horizontal condition, due to software detection and identification of a good balance recovery response.

According to some embodiments, the systems and methods disclosed herein advantageously allow dual tasking training, whereby both a physical training (perturbations) and mental training (cognitive challenge/stimulation (for example, by cognitive task and/or cognitive games) are provided to the user and the performance of the user is further configured to be assessed by the system. The dual tasking training may synergistically act in consequently improving the subject's balance.

In some embodiments, the machine learning algorithms disclosed herein can advantageously be utilized to assess the performance (physical and mental), provide real time feedback to the user, adjust the training level and/or determine a training session.

It is noted that the terms “trainee”, “user”, and “subject” are used interchangeably and are intended to have the same meaning.

The term “walking”, as used herein, refers to “in-place” walking on the supported in-place walking system, when the feet are intended to be constantly supported by steppers.

Unless defined otherwise, all technical and scientific terms used herein have the same meaning as commonly understood by one of ordinary skill in the art to which the invention pertains.

The term “a” and “an” refers to one or to more than one (i.e., to at least one) of the grammatical object of the article. By way of example, “an element” means one element or more than one element.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, the terms “substantially” and “about” may be interchangeable.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to case understanding of the specification and should not be construed as necessarily limiting.

While certain embodiments of the invention have been illustrated and described, it will be clear that the invention is not limited to the embodiments described herein. Numerous modifications, changes, variations, substitutions and equivalents will be apparent to those skilled in the art without departing from the spirit and scope of the present invention as described by the claims, which follow.

The following examples are presented in order to more fully illustrate some embodiments of the invention. They should in no way be construed, however, as limiting the broad scope of the invention. One skilled in the art can readily devise many variations and modifications of the principles disclosed herein without departing from the scope of the invention.

The invention will now be illustrated by the following non-limiting Examples.

### EXAMPLES

### Methods

### System Description

The exemplified system is a mechatronic device weighing about 140 kg that provides 3-dimensional (3D) balance perturbations tilts during in-place walking (see FIG. 1). In the exemplified embodiment, the system is comprised of a stationary elliptical system that is mounted on a motion platform that consists of two direct current (DC) motors and gears connected to them. The exemplified motion platform allows two degrees of freedom, roll and pitch (left-right and forward-backward tilts, respectively) during in-place walking in a safe environment. The system provides a maximum 3D perturbation tilt angle of a maximum 8° (in all directions) with 3 options of rotational strength. The motor that performs the unannounced perturbation tilts is controlled by a motion control system which is controlled also by a camera system (such as, the ZED 2™ from Stereolabs), which are both controlled by a main computer software program. The computer program is on the host PC which also serves as a user interface. By a program command, the motion control system directs the motion platform rotation based on the training plan. The computer software program allows the trainer to determine system perturbation parameters such as the tilt angle of perturbation, rotational strength, direction of rotation, and the interval time between perturbations.

Based on the ZED2 camera, the software is able to capture and identify effective balance reactive reactions after unannounced balance perturbation is given. In case an appropriate balance reactive response is detected by the software i.e., counter-rotation action of body segments, the tilt rotation (i.e., the perturbation) is stopped, and the motor returns the system to its horizontal position (i.e., zero position) by motor counter-rotation. In this way, the trainee gets real-time feedback. The immediate real-time balance reactive response feedback may help the trainee to learn implicitly how to react successfully to unexpected perturbation and provides the best possible motor learning implementation.

### Main System Components

### The Motion Platform

The motion platform includes a platform (on which the elliptical is placed), two 24V DC brushed motors and gears connected to them. To link the rotation of the motors to the tilt of the platform, a four-bar linkage mechanism is attached to each output shaft of the gear. This mechanism allows control over the position of a certain point in a closed kinematic system. Thus, through rotation combinations of the motors, it is possible to control the tilting direction of the platform. The two DC motors with a power rating of 200 W, and the gear is NMRV gear type with a gear ratio of 1:50. Also, the motors have a maximum speed of 105 degrees per second and peak torque of 25 Nm. On the other side of the output shaft of the gear, there is a position sensor that monitors the rotation of each motor. The motion platform is controlled by an Arduino (an open-source electronic platform for interaction with electronic objects) which is located inside an electrical cabinet (the motion platform controller) that came with the platform. The electrical cabinet connects with a USB cable to the PC for the purpose of connecting to an application programming interface (API) called Sim Raising Studio (SRS). This API enables programming of the motion platform using Python software in a convenient and simple way. The stereo camera

The ZED 2™ is a stereo camera mounted at a horizontal plane at a height of 1.05 [m] and 1.8 [m] in behind the trainee's standing position for the best motion capture of the trunk and arms reactions. The ZED 2™ camera is a depth camera in which there is a ready-made and easy-to-use body frame model that maps the human body into a single kinematic chain. This way the ZED 2™ camera captures the body posture in real time and allows implementation of the upper-body balance reactive responses to be monitored and increased. The camera sensors collect the trainee's body movements with respect to the system state and analyzes their responses to ongoing events.

During training, the system calculates predefined angles (α1-α5) of the trainee's body. The angles are calculated using the information received from the camera about the position of the trainee's joints (as seen, e.g., in FIGS. 10A-10B, 11A-11B, and 12A-12B). Upper body joints skeleton stick figures provided by the camera were used because the balance, trunk, and arm movements are the training target. While training, the system calculates the desired angles (α1-α5) and saves them in a CSV file to be able to observe the trainee's reactions and analyze them after training is over. Also, the system collects and saves the tilt angles (α6, α7) that are sent to the motion platform in a CSV file as well. The angles: α1) Shoulder angle: The angle of the line between the trainee's two shoulders and the ground on the left-right axis.; α2) L-R back angle: The angle of the line from the trainee's center of mass (COM) to the trainee's chest relative to the line vertical to the ground on the left-right axis; α3) F-B back angle: The angle of the line from the COM to the chest relative to the line vertical to the ground on the back-front axis; α4) Left elbow angle: The angle between the line from the left elbow to the left shoulder joints of the trainee and the line vertical to the ground on the left-right axis; α5) Right elbow angle: The angle between the line from the right elbow to the right shoulder joints of the trainee and the line vertical to the ground on the left-right axis; α6) System roll angle: The angle of the motion platform on the left-right axis; α7) System pitch angle: The angle of the motion platform on the front-back axis.

Each training consists of two phases: calibration and perturbation. First, by calibrating, the effective balance response threshold during in-place walking on the elliptical is identified and personalized for each trainee. Secondly, during the perturbation phase, when the trainee responds well to perturbations, the system provides a customized intrinsic sensorimotor cue. This is done by stopping the perturbation immediately and returning the system to its horizontal position. Angles α1 and α2 were used in the real-time training process to detect the trainee's body position with respect to the calibration angles to check whether an effective balance reactive response was performed when the system performs roll (left-right) perturbation. Angle α3 was used for the same purpose when the system performs pitch (forward-backward) perturbation. Angles α4-α7 were not used during the real-time training process but are shown in post-training graphs for advanced post-training analysis. Monitoring the trainee's balance responses according to the system movement over time can indicate the implementation of skill acquisition and the motor learning progress of the balance upper-body reactive responses. The data of angles α1-α5 reveals all the information about the balance reactions. For example, the arm reactions (α4 and α5), which are part of the training goal, arc reflected in all types of perturbations, but the other angles that are measured represent a more reliable information about the nature of the response according to the perturbation. Therefore, the position calculation is not based on rhw α4 and α5 angles. However, it can clarify the entire response to perturbations.

### The Control System (PC)

The computer program serves as the control system and runs on the host PC. Using Python software, it is possible to control both systems, the ZED 2™ camera, and the motion platform, and even to communicate between them. Python software activates both systems simultaneously. Thus, the system knows the position of the user and, as a result, the angles of his body due to the ZED 2™ camera. The desired perturbation can be created while controlling the motion platform. The motion platform is controlled by the API, as mentioned above, by sending commands for the type of perturbation, the size of its angle and its intensity. The API receives the information and sends the translated information to the controller of the motion platform that takes care of care of moving the motors according to the command sent.

Safety harness

Safety is an extremely important issue since, in this training, unexpected perturbations are applied, that may cause the trainee to fall off the system. A safety harness keeps the trainee secure during training. For the exemplified safety system, there are two options to secure the trainer according to the nature of the required system: mobile or stationary. For a mobile system (see FIG. 6), a waist harness is used to secure this system. Four adjustable straps are attached to this harness, two on each side (right and left), when each of which is fixed to one of the four side rods of the system. This system is mobile because it does not depend on the site in which it is placed. For a stationary system (see FIG. 7), a body harness is used to secure this system. The safety harness is suspended from the ceiling by two ropes above the trainee. This system is stationary because it is necessary to fix the straps to which the harness is attached to the ceiling of the site where the system is placed. The experimenters were secured to this system. In both systems, the harness is slightly loose to be safe, and does not restrict balance response, but in case the trainee fails to recover, the safety harness arrests the fall.

### Software

The program can be written with Python software and the type of training may be selected by answering questions at the beginning of the training run.

### The Training

### Defining Training Parameters

When running the program, at first the system asks the trainer to enter the length of the workout in minutes. This time includes the first two minutes of system calibration. Following that, the trainer defines training content by defining segments of perturbations based on his preferences.

Each perturbation is defined separately and added in chronological order to the training. For each segment of perturbations, the trainer sets the duration of the segment, the type of the perturbations (the tilting direction, the size of its angle, its intensity (range between 1 to 3), and the delay time between each two consecutive perturbations (frequency). Defining segments ends when all the defined training minutes have been used. After creating the training, the system is activated, and the trainee is instructed to start walking on the elliptical. In the first two minutes of the training, the system is calibrated according to the trainee trunk motion, so there are no perturbations in this part. The purpose of this part is to define the range of user trunk and shoulders angles when the user walks on the system while it is at rest (no perturbations). After this time, the perturbations begin according to the training trunk and shoulders segments that the trainer created. Also, the system saves the calculated trunk and shoulders angles of the trainer and the system angles perturbations in a CSV file.

### Types of Perturbations

The system provides 3D tilting balance perturbations that aim to challenge specifically trunk, and upper body balance reactive reactions but also lower-limb reactive responses are triggered. When tilting, the trainee's COM aside rapidly, the trainee is forced to decelerate the CoM by responding reactively with lower-limbs, trunk and upper limb balance reactive response during in place walking. Balance perturbations are provided in two forms: 1) machine-induced unannounced external perturbations and 2) self-induced internal perturbations during hands-free in place walking. The external perturbations are controlled programmed machine-induced and range from low to high magnitude (0°-8° for each direction). They can be programmed expectedly as a block perturbation training (fixed time, order, and magnitude), or be given unexpectedly as random perturbation training (in onset, direction, and time interval) which evoke fast trunk and upper-body reactive balance motion. The internal self-induced perturbations are provided by the trainee during self-pace in place walking on the. These situations fall under proactive balance control training when the trainee shift his/her body weight during the elliptical in place walking.

### System Communication and Activation

To activate the system, the PC (in the central control unit) must be able to access the motion platform controller, i.e., by turning on the motion platform controller and open the application. Next, for running a training program, a customized perturbation training program must be created (e.g., by the user or together with a trainer) by using the user interface (activate Python software). When the computer program runs the training program by utilizing the motion control system and the ZED 2™ camera, both are controlled by the computer program on the central control unit. Communication between the two systems (the camera and the motion control system) must be enabled to produce implicit feedback for the trainee. The camera transmits information about the trainee's shoulder trunk and arms movements, while the motion control system is responsible for receiving information from and delivering commands to the motors. In case the software detects an appropriate trunk balance reactive response during a perturbation i.e., counter rotating the trunk and shoulder, the perturbation is stopped, and returns to its horizontal position. Also, with the help of the graphics library (GL), the system displays the camera image with the body frame (body sticks diagram) throughout the training session.

After the training program, the trainer may review the trainee's balance reactive movement graphs, check if an effective reactive response was triggered and balance was recovered and data collected in order to determine how to proceed in the next training session.

### The 3D Camera Function During the Training

The training session is divided into two stages: 1) the calibration stage (the first 2 minutes) and 2) the balance exercise stage.
1) The calibration stage—for automatically customizing the system to the trainee who is currently using it. It consists of two parts:
A) The trainee's adaptation phase—20 seconds of warning-up slow walking to allow the trainee to case into a comfortable position. In this phase, the computer program does not make any reference point calculations due to the noisy data that was gathered by the camera until the trainee gets used to walking on the elliptical.
B) Measuring and calculating each individual upper body sway (forward-backward and left-right) trunk angle; the body sway base noise range (natural angles)—100 seconds of self-paced walking while the ZED 2™ camera provides data to the computer program for calculating angles α1-α5. At the end of the calibration stage, the reference angles that are used to determine whether the trainee's reactive balance responses were effective or not are obtained. Based on the defined natural body sway angles, the computer program detects if the trainee responded to a given perturbation or whether their current trunk and shoulder angle was a part of natural movement during walking (i.e., into the body-sway-base-noise range). Thus, first, the computer program records the data of the α1-α5 angles during the 100-seconds of calibrated self-paced in place walking. And secondly, throughout the calibration phase, the system updates the noise domain of angels α1-α3 according to the update of the maximum trunk and shoulder angles obtained from the calculation. The natural movements are the angles at which the trainee is naturally walking in place, and this is necessary because often older people naturally tend to lean a few degrees to either the left, right, forward, or backward side.
2) The balance exercise stage—contains block and expected or random and unexpected balance perturbations. When a new perturbation is executed, the computer program compares between the trainee's trunk and shoulder angles (which are calculated and kept continuously throughout the training) to the natural angles range. This is to see if there has been a significant movement other than a walking movement.

For separating a balance reactive response to a normal self-induced voluntary walking movement following a perturbation, the system is programed to check these conditions: If the motion platform angle and the trainee's body are leaning in opposite directions, and if the current body angle is larger than the natural angle of this side self-induced walking. This tilt requires the trainee for a larger distinct balance reactive response to recover their balance for passing above the response threshold and stopping the perturbation by turning the platform angle back to its neutral position (horizontal to the ground). This option deals with a trainee who exhibits large trunk and shoulders angles during the exercise session versus the calibration phase.

### Example 1: Balance Reactive Responses

To explore whether the software was able to identify balance reactive responses, the following experiment was conducted: two young adults were exposed to unannounced right-left and anterior-posterior balance perturbations while in-place walking on the system. The tilting perturbations evoked balance reactive trunk, head, and arm movements always in the opposite direction of the perturbation to quickly move the upper body's center of mass (COM) toward the base of support provided by the steppers. Both subjects performed upper body balance reactive responses during the training session.

The trunk, shoulder and arms reactive responses during the training sessions arc demonstrated in FIGS. 10A-B and 11A-B. Upper body balance reactive responses are presented by the shoulder line and trunk/back and arms angles. These angles were found to be the best parameters to distinguish the presence of an upper body balance reactive response.

In FIGS. 10A-10B, the subject walked with, and then without, holding the elliptical system handlebars (i.e., hands-free). Then the subject was exposed to 8° right announced perturbations during hands-free in-place walking (FIG. 10A). FIGS. 10B shows that the software was able to accurately identify shoulder and trunk/back balance reactive responses and return the system to its initial horizontal plane.

In FIGS. 11A-11B, the subject walked with, and then without, holding the elliptical system handlebars (i.e., hands-free). Then the subject was exposed to 8° left announced perturbations during hands-free in-place walking (FIG. 11A). FIG. 11B shows that the software was able to accurately identify shoulder and trunk/back balance reactive responses and return the system to its initial horizontal plane. In FIGS. 12A-12B, the subject walked with, and then without, holding the elliptical system handlebars (i.e., hands-free). Then the subject was exposed to 8° backward announced perturbations during hands-free in-place walking (FIG. 12A). FIG. 12B shows that the software was able to accurately identify trunk/back and arms balance reactive responses and return the system to its initial horizontal plane.

Observing and analyzing a trainee's balance reactive performance can be useful for making a clinical decision regarding the progress of rehabilitation, and for indicating skill acquisition and motor learning progress of the balance upper bodies reactive responses. Additional software enables the trainer to observe the kinematic data of a specific trainee in a specific training session. It presents kinematic graphs and a moveable timeline that allows the trainer to observe the upper bodies angles and the camera's body stick figure at every timestamp, compared to the horizontal angle position of the at that timestamp.

1. A perturbed walking training system for improving balance control in a subject, the system comprising:
a movable platform;
a supported in-place walking trainer (SUIT) mounted on the movable platform, the SUIT comprising a first stepper operably connected to a first shaft and a second stepper operably connected to a second shaft;
at least one platform motor configured to control movement of the platform; and
a central control unit,
wherein the system is configured to administer unexpected external perturbations to the SUIT at least by moving the platform, thereby inducing balance reactions in the subject.

2. (canceled)

3. The system according to claim 1, wherein the system further comprises a platform gear mechanism configured to allow transmission of platform motor rotation with a rotation axis of the platform by one or more ball bearings, thereby allowing rotation and external platform-induced perturbations.

4. The system of claim 1, wherein the first stepper is connected to a first stepper motor controlling movement of the first stepper, and the second stepper is connected to a second stepper motor controlling the movement of the second stepper.

5. (canceled)

6. The system according to claim 1, wherein the system further comprises at least one stepper gear mechanism configured to allow transmission of rotation from the first stepper motor and/or the second stepper motor with a rotation axis of the first stepper and/or the second stepper by one or more ball bearings, thereby allowing rotation and the external stepper-induced perturbations of the first stepper and/or the second stepper.

7. The system according to claim 1, wherein the unexpected external perturbations are platform-induced perturbations and/or stepper-induced perturbations.

8. The system according to claim 1, wherein the unexpected external perturbations are provided in a triangular motion profile (acceleration-deceleration) for each perturbation.

9. (canceled)

10. The system according to claim 1, wherein the unexpected external perturbations are selected from the group consisting of: lateral perturbations (roll, left and right tilt), antero-posterior perturbations (pitch, forward and backward tilt), vertical perturbations, rotations around a vertical axis, and any combination thereof.

11. (canceled)

12. (canceled)

13. (canceled)

14. (canceled)

15. (canceled)

16. The system of claim 1, wherein the first shaft and the second shaft are operably connected to at least one shaft mechanism.

17. The system of claim 16, wherein the first shaft and the second shaft are operably connected to a single shaft mechanism which is configured to control resistance of the first shaft and the second shaft.

18. (canceled)

19. (canceled)

20. (canceled)

21. The system of claim 1, further comprising a harness.

22. The system of claim 21, wherein the harness is configured to secure the subject during perturbations.

23. The system of claim 21, wherein the harness is configured to provide pull perturbations to the subject.

24. The system according to claim 1, further comprising a motion control system unit as part of the central control unit, and/or a motion capture unit.

25. (canceled)

26. (canceled)

27. The system according to claim 24, wherein the central control unit is configured to control operation parameters of the motion control unit and/or of the motion capture unit.

28. The system according to claim 1, further comprising a user interface and/or a display.

29. (canceled)

30. The system according to claim 1, wherein the central control unit comprises a processing unit configured to execute a computer program configured to determine performance of the subject during perturbations and/or define further perturbations training sessions.

31. (canceled)

32. (canceled)

33. (canceled)

34. The system according to claim 30, wherein the training session comprises operating parameters selected from the group consisting of: type of perturbation, maximum acceleration/deceleration of a perturbation, maximum angular velocity of a perturbation, magnitude of a perturbation, angle of perturbation, number of perturbation repetitions, the delay time between the perturbations, and any combination thereof.

35. The system according to claim 30, wherein the processing unit is configured to provide real-time feedback to the subject regarding reactive balance reaction following a single perturbation or perturbation session.

36. (canceled)

37. (canceled)

38. (canceled)

39. (canceled)

40. A method for training or improving balance control of a subject, the method comprising:
providing one or more unexpected external perturbations to a subject using the system of claim 1, further comprising a motion capture unit and a processing unit;
detecting a reactive balance response of the subject to the unexpected external perturbations based on data acquired by the motion capture unit of the system;
analyzing the detected reactive and proactive balance response of the subject; and
providing feedback to the subject if the balance response is determined to be above a balance response threshold.

41.-51. (canceled)
